(19) United States
(12) Patent Application Publication
(10) Pub. No.: US 2026/0120443 A1
(43) Pub. Date: Apr. 30, 2026

(54) Perception System for Autonomous Vehicles

(71) Applicant: Aurora Operations, Inc., Pittsburgh, PA (US)

(72) Inventor: Hanzhang Hu, Pittsburgh, PA (US)

(21) Appl. No.: 18/933,594

(22) Filed: Oct. 31, 2024

(51) Int. Cl. G06V 10/776; B60W 60/00; G06V 10/70; G06V 10/75; G06V 10/764; G06V 10/766; G06V 10/82; G06V 20/58

(52) U.S. Cl. CPC G06V 10/776; B60W 60/001; G06V 10/75; G06V 10/764; G06V 10/768; G06V 10/82; G06V 20/58; B60W 2420/403; B60W 2420/408; B60W 2554/4042; G06V 10/766

(57) ABSTRACT

An example method includes generating, based on sensor data representing an environment, a plurality of proposed detection outputs corresponding to a plurality of positions in a representation of the environment, wherein a detection output of the plurality of proposed detection outputs indicates a proposed detected object in the environment and comprises an initial value corresponding to an initial likelihood for an attribute of the proposed detected object; generating, by a component that receives input including local context data and the initial value, an updated value for the attribute, wherein the updated value corresponds to an updated likelihood for the attribute, and wherein the local context data comprises, for a location in the environment associated with the proposed detected object, a portion of the sensor data or a portion of latent feature data; and generating an object detection output based on the updated value.

### BACKGROUND

An autonomous platform can process data to perceive an environment through which the autonomous platform travels. For example, an autonomous vehicle can perceive its environment using a variety of sensors and identify objects around the autonomous vehicle. The autonomous vehicle can identify an appropriate path through the perceived surrounding environment and navigate along the path with minimal or no human input.

### SUMMARY

Example implementations of the present disclosure provide for improved object detection system architectures and training techniques for improving an ability of autonomous vehicles to navigate in dynamic real-world environments. In an example aspect, a perception system architecture may include two stages: a proposal stage and a refinement stage. A proposal stage may process sensor data and generate proposed object detections. A refinement stage may process the proposed object detections in view of one or more object detection primitives (e.g., the raw sensor data or latent features generated from the sensor data) to update the predictions for obtaining a refined object detection output.

This two-stage architecture may facilitate improved accuracy and processing efficiency. Accuracy may be improved by exposing the refinement stage to lower level object detection primitives. For example, with traditional neural networks, the output layers (which may be responsible for generating the final output predictions) may be far removed from the original inputs and the low level primitives. In contrast, an example refinement stage according to aspects of the present disclosure may advantageously have access to the raw sensor data or latent features generated from the sensor data so that the output predictions may be adapted in full view of the original scene contexts. This access to low-level primitives may not only provide improved signal strength for underlying sensor data features (e.g., not attenuated through as many intervening layers) but may also mitigate compounding errors through layers of the model. In this manner, for instance, example implementations of the present disclosure may provide more accurate or reliable computation of detections.

Processing efficiency may be improved by disentangling a domain precision over which the different respective stages operate. For example, traditional object detection systems may generally suffer from an inherent tradeoff between computational cost and precision. For example, a precision of object detection may be measured in terms of a minimum precision with which it can locate an object in the environment. For instance, an image-based object detection system may return, for a group of one or more pixels, whether the group contains at least part of an object. Under such traditional schemes, computational cost may be directly proportional to the number of groups, and precision may be inversely proportional to the size of the groups. As such, for a given region size (e.g., image size), smaller groups generally require a greater number of groups, thereby placing computational cost and precision in tension. In contrast, an example proposal stage according to aspects of the present disclosure may generate predictions for a series of predetermined positions in an environment. These positions may be selected to coarsely cover a broad region to optimize allocation of computing resources to provide strong recall over a broad range of detection. Subsequently, a refinement stage may be configured to activate only over local regions surrounding proposed detections. With this more focused scope, the refinement stage may more effectively allocate processors to increase precision and detection sensitivity in localized areas. The precision of the refinement stage may not demand any increased computational effort by the proposal stage. In this manner, for instance, example implementations of the present disclosure may provide more efficient computation over an increased range of detections.

In an example aspect, a perception system may be trained using a loss function that uses a computed match value as a ground truth reference for prediction values output by the perception system. For example, a training dataset may include labeled sensor data that describes a plurality of objects in an environment. The sensor data may be input to a perception system, and the perception system may generate an object detection output. The object detection output may indicate a detected object that has a particular category and is defined by a boundary. A loss may be computed to evaluate the object detection output. The loss may be configured to penalize class prediction values (e.g., values that indicate class probabilities) that do not align with a match value (e.g., which may indicate an agreement between the predicted boundary and a ground truth boundary). The match value may be computed using a machine-learned matching model that is trained to output a match value that indicates that two bounding box predictions are materially similar in context.

For instance, for some scenarios, if a ground truth object of class “A” is present at a location that matches the prediction location (e.g., a high match value), the probability associated with class “A” should indicate as much (e.g., a high probability value for the class); if the prediction location does not match the ground truth location (e.g., a low match value), the probability associated with class “A” should indicate that there is not an object of class “A” at that location (e.g., a low probability value for the class). In this manner, then, a perception system may be trained using a loss function that uses a computed match value as a ground truth reference for prediction values output by the perception system.

Using a computed match value as a reference may improve performance of the perception system while simplifying the training task. For example, object detection outputs may be interdependent. Providing independent penalties for bounding box location and class probability may not always address interdependence between the prediction tasks. For example, consider a correct classification output in an incorrect location: independent losses might tend to reinforce the behavior that predicted the class correctly while simultaneously penalizing the behavior that predicted the location incorrectly. This may lead to increases in false positive detections, false negative detections, etc. In contrast, using a loss function that uses a computed match value as a ground truth reference for prediction values output by the perception system may alleviate this tension by unifying the prediction objective.

Further, using a computed match value from a machine-learned matching model that evaluates whether two bounding box predictions are materially similar in context may further improve the contextual sensitivity and accuracy of the perception system. For example, requiring identity between the perception output and the label may in some instances render the problem intractable or lead to undesirable outcomes (e.g., overfitting, overly complex models). In practice, a goal of a perception system may be to capture sufficiently accurate information that would enable the same set of reasonable reactions as would be enabled by ground truth information. For example, a 20 cm error in a lateral lane position of a vehicle at a distance of 200 m may not affect reasonable navigation of the scene as compared to the ground truth lane position. The same magnitude error when the vehicle is alongside the ego position may affect the reasonable navigation of the scene as compared to the ground truth lane position.

In this manner, for instance, a perception system trained using a context-sensitive loss based on a match value generated using a machine-learned matching model may be more attentive to the scene context that materially affects prediction performance demands. Further, by focusing the objective to only penalize material errors, the training of the perception system may minimize or avoid updates that optimize for immaterial improvements at the expense of material errors.

In an aspect, the present disclosure provides a first example method. In some implementations, the first example method includes generating, by a first stage of a perception system of an autonomous vehicle and based on sensor data representing an environment, a plurality of proposed detection outputs corresponding to a plurality of positions in a representation of the environment, wherein a detection output of the plurality of proposed detection outputs indicates a proposed detected object in the environment and includes an initial value corresponding to an initial likelihood for an attribute of the proposed detected object. In some implementations, the first example method includes generating, by a second stage of the perception system that receives input including local context data and the initial value, an updated value for the attribute, wherein the updated value corresponds to an updated likelihood for the attribute, and wherein the local context data includes, for a location in the environment associated with the proposed detected object, a portion of the sensor data or a portion of latent feature data generated by the first stage. In some implementations, the first example method includes generating an object detection output based on the updated value for the attribute. In some implementations, the first example method includes controlling the autonomous vehicle based on the object detection output.

In an aspect, the present disclosure provides a second example method. In some implementations, the second example method includes generating, by a first stage of a perception system of an autonomous vehicle and based on sensor data representing an environment, a plurality of proposed detection outputs corresponding to a plurality of positions in a representation of the environment, wherein a detection output of the plurality of proposed detection outputs indicates a proposed detected object in the environment and includes an initial value corresponding to an initial likelihood for an attribute of the proposed detected object. In some implementations, the second example method includes generating, by a second stage of the perception system that receives input including local context data and the initial value, an updated value for the attribute, wherein the updated value corresponds to an updated likelihood for the attribute, and wherein the local context data includes, for a location in the environment associated with the proposed detected object, a portion of the sensor data or a portion of latent feature data generated by the first stage. In some implementations, the second example method includes generating an object detection output based on the updated value for the attribute. In some implementations, the second example method includes training at least one of the first stage or the second stage based on the object detection output.

In an aspect, the present disclosure provides a third example method. In some implementations, the third example method includes generating, using a perception system for an autonomous vehicle to process sensor data representing an environment, an object detection output indicating an object boundary and a prediction value for an attribute of a detected object in the environment. In some implementations, the third example method includes generating a match value using a matching model that evaluates a match quality between the object boundary and a ground truth object boundary. In some implementations, the third example method includes computing a loss that evaluates the prediction value against the match value. In some implementations, the third example method includes updating, using the loss, one or more learnable parameters of the perception system.

In an aspect, the present disclosure provides example non-transitory computer readable media storing instructions that are executable by one or more processors to cause a computing system to perform one or more operations of any one or more implementations of the first example method, the second example method, or the third example method. In some implementations, the computing system is a computing system for controlling an autonomous vehicle, such as an autonomous vehicle control system. The computing system may be a simulation computing system configured to simulate the operations of an autonomous vehicle, such as by simulating the operations of an autonomous vehicle control system. The computing system may be a training computing system configured to train one or more machine-learned models of a perception system.

In one example aspect, the present disclosure provides an example computing system comprising one or more processors and non-transitory computer readable media storing instructions that are executable by the one or more processors to cause the example computing system to perform one or more operations of any one or more implementations of the first example method, the second example method, or the third example method. In some implementations, the computing system is a computing system for controlling an autonomous vehicle, such as an autonomous vehicle control system. The computing system may be a simulation computing system configured to simulate the operations of an autonomous vehicle, such as by simulating the operations of an autonomous vehicle control system. The computing system may be a training computing system configured to train one or more machine-learned models of a perception system.

In an aspect, the present disclosure provides an example autonomous vehicle control system for controlling an autonomous vehicle. In some implementations, the example autonomous vehicle control system includes a perception system that includes one or more sensors. In some implementations, the example autonomous vehicle control system includes one or more processors. In some implementations, the example autonomous vehicle control system includes one or more non-transitory, computer-readable media storing instructions that are executable by the one or more processors to cause the autonomous vehicle control system to perform operations. In some implementations, the operations include generating, by the one or more sensors, sensor data representing an environment. In some implementations, the operations include generating, by a first stage of the perception system and based on the sensor data, a plurality of proposed detection outputs corresponding to a plurality of positions in a representation of the environment, wherein a detection output of the plurality of proposed detection outputs indicates a proposed detected object in the environment and includes an initial value corresponding to an initial likelihood for an attribute of the proposed detected object. In some implementations, the operations include generating, by a second stage of the perception system that receives input including local context data and the initial value, an updated value for the attribute, wherein the updated value corresponds to an updated likelihood for the attribute, and wherein the local context data includes a portion of the sensor data or a portion of latent feature data generated by the first stage, for a location in the environment associated with the proposed detected object. In some implementations, the operations include generating an object detection output based on the updated value for the attribute. In some implementations, the operations include controlling the autonomous vehicle based on the object detection output.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims.

### BRIEF DESCRIPTION OF THE DRAWINGS

The accompanying drawings, which are incorporated in and constitute a part of this specification, illustrate implementations of the present disclosure and, together with the description, serve to explain the related principles.

FIG. 1 is a block diagram of an example operational scenario, according to some implementations of the present disclosure.

FIG. 2 is a block diagram of an example system, according to some implementations of the present disclosure.

FIG. 3A is a representation of an example operational environment, according to some implementations of the present disclosure.

FIG. 3B is a representation of an example map of an operational environment, according to some implementations of the present disclosure.

FIG. 3C is a representation of an example operational environment, according to some implementations of the present disclosure.

FIG. 3D is a representation of an example map of an operational environment, according to some implementations of the present disclosure.

FIG. 4 is a block diagram of aspects of an example system for a perception system according to example aspects of the present disclosure.

FIG. 5 is a block diagram of aspects of an example system for a perception system according to example aspects of the present disclosure.

FIG. 6 is a block diagram of aspects of an example system for a perception system according to example aspects of the present disclosure.

FIG. 7 is a block diagram of aspects of an example system for a perception system according to example aspects of the present disclosure.

FIG. 8 is a block diagram of aspects of an example system for a perception system according to example aspects of the present disclosure.

FIG. 9 is a block diagram of aspects of an example system for a perception system according to example aspects of the present disclosure.

FIG. 10 is a block diagram of aspects of an example system for a perception system according to example aspects of the present disclosure.

FIG. 11 is a block diagram of aspects of an example system for a perception system according to example aspects of the present disclosure.

FIG. 12 is a flowchart of an example method for executing at least a portion of a perception system, according to some implementations of the present disclosure.

FIG. 13 is a flowchart of an example method for training at least a portion of a perception system, according to some implementations of the present disclosure.

FIG. 14 is a flowchart of an example method for training at least a portion of a perception system, according to some implementations of the present disclosure.

FIG. 15 is a flowchart of an example method for training a machine-learned operational system, according to some implementations of the present disclosure.

FIG. 16 is a block diagram of an example computing system, according to some implementations of the present disclosure.

### DETAILED DESCRIPTION

The following describes the technology of this disclosure within the context of an autonomous vehicle for example purposes only. As described herein, the technology described herein is not limited to an autonomous vehicle and may be implemented for or within other autonomous platform 110s and other computing systems.

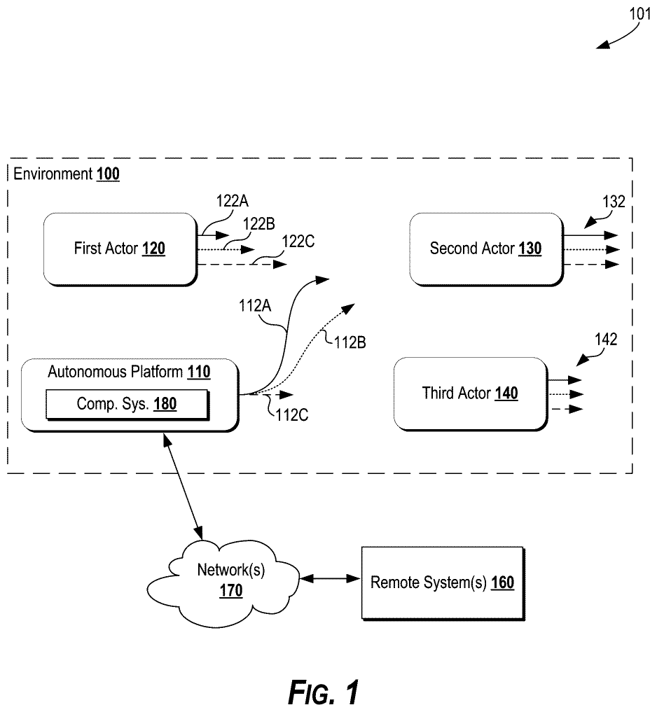

With reference to FIGS. 1-16, example implementations of the present disclosure are discussed in further detail. FIG. 1 is a block diagram of an example operational scenario 101, according to some implementations of the present disclosure. In the example operational scenario, an environment 100 contains an autonomous platform 110 and a number of objects, including first actor 120, second actor 130, and third actor 140. In the example operational scenario, autonomous platform 110 may move through the environment 100 and interact with the object(s) that are located within the environment 100 (e.g., first actor 120, second actor 130, third actor 140). Autonomous platform 110 may optionally be configured to communicate with remote system(s) 160 through network(s) 170.

The environment 100 may be or include an indoor environment (e.g., within one or more facilities) or an outdoor environment. An indoor environment, for example, may be an environment enclosed by a structure such as a building (e.g., a service depot, maintenance location, manufacturing facility). An outdoor environment, for example, may be one or more areas in the outside world such as, for example, one or more rural areas (e.g., with one or more rural travel ways), one or more urban areas (e.g., with one or more city travel ways, highways), one or more suburban areas (e.g., with one or more suburban travel ways), or other outdoor environments.

Autonomous platform 110 may be any type of platform configured to operate within the environment 100. For example, autonomous platform 110 may be a vehicle configured to autonomously perceive and operate within the environment 100. The vehicles may be a ground-based autonomous vehicle such as, for example, an autonomous car, truck, van. Autonomous platform 110 may be an autonomous vehicle that may control, be connected to, or be otherwise associated with implements, attachments, and/or accessories for transporting people or cargo. This may include, for example, an autonomous tractor optionally coupled to a cargo trailer. Additionally, or alternatively, autonomous platform 110 may be any other type of vehicle such as one or more aerial vehicles, water-based vehicles, space-based vehicles, other ground-based vehicles

Autonomous platform 110 may be configured to communicate with the remote system(s) 160. For instance, the remote system(s) 160 may communicate with autonomous platform 110 for assistance (e.g., navigation assistance, situation response assistance), control (e.g., fleet management, remote operation), maintenance (e.g., updates, monitoring), or other local or remote tasks. In some implementations, the remote system(s) 160 may provide data indicating tasks that autonomous platform 110 should perform. For example, as further described herein, the remote system(s) 160 may provide data indicating that autonomous platform 110 is to perform a trip/service such as a user transportation trip/service, delivery trip/service (e.g., for cargo, freight, items)

Autonomous platform 110 may communicate with the remote system(s) 160 using the network(s) 170. The network(s) 170 may facilitate the transmission of signals (e.g., electronic signals) or data (e.g., data from a computing device) and may include any combination of various wired (e.g., twisted pair cable) or wireless communication mechanisms (e.g., cellular, wireless, satellite, microwave, radio frequency) or any desired network topology (or topologies). For example, the network(s) 170 may include a local area network (e.g., intranet), a wide area network (e.g., the Internet), a wireless LAN network (e.g., through Wi-Fi), a cellular network, a SATCOM network, a VHF network, an HF network, a WiMAX based network, or any other suitable communications network (or combination thereof) for transmitting data to or from autonomous platform 110.

As shown for example in FIG. 1, environment 100 may include one or more objects. The object(s) may be objects not in motion or not predicted to move (“static objects”) or object(s) in motion or predicted to be in motion (“dynamic objects,” such as “actors”). In some implementations, the environment 100 may include any number of actor(s) such as, for example, one or more pedestrians, animals, vehicles. The actor(s) may move within environment 100 according to one or more actor trajectories. For instance, the first actor 120 may move along any one of the first actor trajectories 122A-C, the second actor 130 may move along any one of the second actor trajectories 132, the third actor 140 may move along any one of the third actor trajectories 142

As further described herein, autonomous platform 110 may utilize its autonomy system(s) to detect these actors (and the movement of the actors) and plan its motion to navigate through environment 100 according to one or more platform trajectories 112A-C. Autonomous platform 110 may include onboard computing system(s) 180. The onboard computing system(s) 180 may include one or more processors and one or more memory devices. The one or more memory devices may store instructions executable by the one or more processors to cause the one or more processors to perform operations or functions associated with autonomous platform 110, including implementing its autonomy system(s).

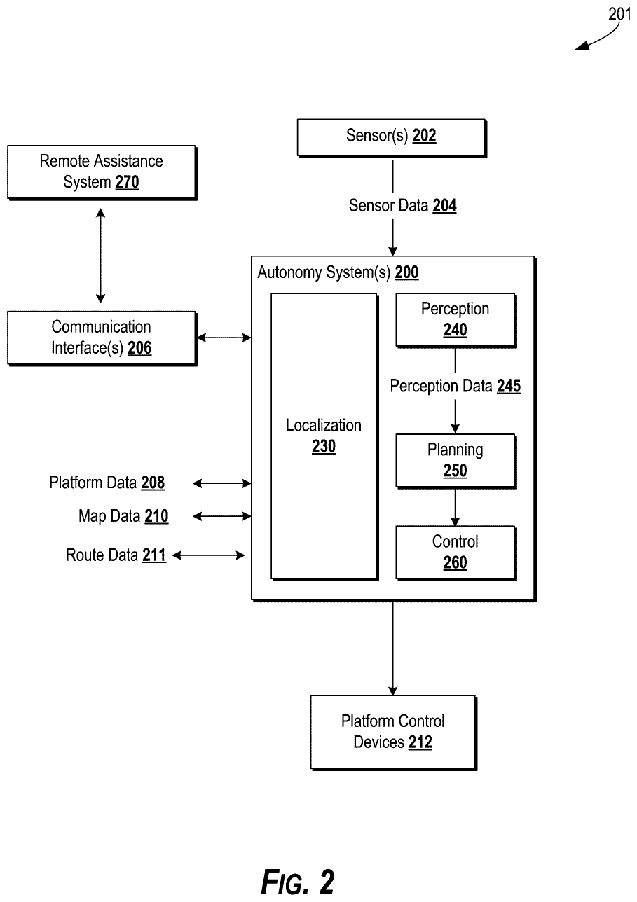

FIG. 2 is a block diagram of an example system 201 including an example autonomy system 200 for an autonomous platform 110, according to some implementations of the present disclosure. In some implementations, the autonomy system 200 may be implemented by a computing system of autonomous platform 110 (e.g., the onboard computing system(s) 180 of autonomous platform 110). The autonomy system 200 may operate to obtain inputs from sensor(s) 202 or other input devices. In some implementations, the autonomy system 200 may additionally obtain platform data 208 (e.g., map data 210, route data 211) from local or remote storage. The autonomy system 200 may generate control outputs for controlling autonomous platform 110 (e.g., through platform control devices 212) based on sensor data 204, map data 210, or other data. The autonomy system 200 may include different subsystems for performing various autonomy operations. The subsystems may include a localization system 230, a perception system 240, a planning system 250, and a control system 260. The localization system 230 may determine the location of autonomous platform 110 within its environment; the perception system 240 may detect, classify, and track objects in the environment; the planning system 250 may determine a trajectory for autonomous platform 110; and the control system 260 may translate the trajectory into vehicle controls for controlling autonomous platform 110. The autonomy system 200 may be implemented by one or more onboard computing system(s). The subsystems may include one or more processors and one or more memory devices. The one or more memory devices may store instructions executable by the one or more processors to cause the one or more processors to perform operations or functions associated with the subsystems. The computing resources of the autonomy system 200 may be shared among its subsystems, or a subsystem may have a set of dedicated computing resources.

In some implementations, the autonomy system 200 may be implemented for or by an autonomous vehicle (e.g., a ground-based autonomous vehicle). The autonomy system 200 may perform various processing techniques on inputs (e.g., the sensor data 204, the map data 210) to perceive and understand the surrounding environment of the vehicle and generate an appropriate set of control outputs to implement a vehicle motion plan (e.g., including one or more trajectories) for traversing the surrounding environment of the vehicle (e.g., environment 100 of FIG. 1). In some implementations, an autonomous vehicle implementing the autonomy system 200 may drive, navigate, or operate with minimal or no interaction from a human operator (e.g., driver, pilot).

In some implementations, autonomous platform 110 may be configured to operate in a plurality of operating modes. For instance, autonomous platform 110 may be configured to operate in a fully autonomous (e.g., self-driving) operating mode in which autonomous platform 110 is controllable without user input (e.g., may drive and navigate with no input from a human operator present in the autonomous vehicle or remote from the autonomous vehicle). Autonomous platform 110 may operate in a semi-autonomous operating mode in which autonomous platform 110 may operate with some input from a human operator present in autonomous platform 110 (or a human operator that is remote from autonomous platform 110). In some implementations, autonomous platform 110 may enter into a manual operating mode in which autonomous platform 110 is fully controllable by a human operator (e.g., human driver) and may be prohibited or disabled (e.g., temporary, permanently) from performing autonomous navigation (e.g., autonomous driving). Autonomous platform 110 may be configured to operate in other modes such as, for example, park or sleep modes (e.g., for use between tasks such as waiting to provide a trip/service, recharging). In some implementations, autonomous platform 110 may implement vehicle operating assistance technology (e.g., collision mitigation system, power assist steering), for example, to help assist the human operator of autonomous platform 110 (e.g., while in a manual mode).

Autonomy system 200 may be located onboard (e.g., on or within) an autonomous platform 110 and may be configured to operate autonomous platform 110 in various environments. Environment 100 may be a real-world environment or a simulated environment. In some implementations, one or more simulation computing devices may simulate one or more of: the sensors 202, the sensor data 204, communication interface(s) 206, the platform data 208, or the platform control devices 212 for simulating operation of the autonomy system 200.

In some implementations, the autonomy system 200 may communicate with one or more networks or other systems with the communication interface(s) 206. The communication interface(s) 206 may include any suitable components for interfacing with one or more network(s) (e.g., the network(s) 170 of FIG. 1), including, for example, transmitters, receivers, ports, controllers, antennas, or other suitable components that may help facilitate communication. In some implementations, the communication interface(s) 206 may include a plurality of components (e.g., antennas, transmitters, or receivers) that allow it to implement and utilize various communication techniques (e.g., multiple-input, multiple-output (MIMO) technology).

In some implementations, the autonomy system 200 may use the communication interface(s) 206 to communicate with one or more computing devices that are remote from autonomous platform 110 (e.g., the remote system(s) 160) over one or more network(s) (e.g., the network(s) 170). For instance, in some examples, one or more inputs, data, or functionalities of the autonomy system 200 may be supplemented or substituted by a remote system communicating over the communication interface(s) 206. For instance, in some implementations, the map data 210 may be downloaded over a network to a remote system using the communication interface(s) 206. In some examples, one or more of localization system 230, perception system 240, planning system 250, or control system 260 may be updated, influenced, nudged, communicated with by a remote system for assistance, maintenance, situational response override, management

Sensors 202 may be located onboard autonomous platform 110. In some implementations, sensors 202 may include one or more types of sensor(s). For instance, one or more sensors may include image capturing device(s) (e.g., visible spectrum cameras, infrared cameras). Additionally, or alternatively, sensors 202 may include one or more depth capturing device(s). For example, sensors 202 may include one or more Light Detection and Ranging (LIDAR) sensor(s) or Radio Detection and Ranging (RADAR) sensor(s). Sensors 202 may be configured to generate point data descriptive of at least a portion of a three-hundred-and-sixty-degree view of the surrounding environment. The point data may be point cloud data (e.g., three-dimensional LIDAR point cloud data, RADAR point cloud data). In some implementations, one or more of sensors 202 for capturing depth information may be fixed to a rotational device in order to rotate sensors 202 about an axis. Sensors 202 may be rotated about the axis while capturing data in interval sector packets descriptive of different portions of a three-hundred-and-sixty-degree view of a surrounding environment of autonomous platform 110. In some implementations, one or more of sensors 202 for capturing depth information may be solid state.

Sensors 202 may be configured to capture the sensor data 204 indicating or otherwise being associated with at least a portion of the environment of autonomous platform 110. The sensor data 204 may include image data (e.g., 2D camera data, video data), RADAR data, LIDAR data (e.g., 3D point cloud data), audio data, or other types of data. In some implementations, the autonomy system 200 may obtain input from additional types of sensors, such as inertial measurement units (IMUs), altimeters, inclinometers, odometry devices, location or positioning devices (e.g., GPS, compass), wheel encoders, or other types of sensors. In some implementations, the autonomy system 200 may obtain sensor data 204 associated with particular component(s) or system(s) of an autonomous platform 110. This sensor data 204 may indicate, for example, wheel speed, component temperatures, steering angle, cargo or passenger status In some implementations, the autonomy system 200 may obtain sensor data 204 associated with ambient conditions, such as environmental or weather conditions. In some implementations, the sensor data 204 may include multi-modal sensor data. The multi-modal sensor data may be obtained by at least two different types of sensor(s) (e.g., of the sensors 202) and may indicate static object(s) (e.g., actor(s)) within an environment of autonomous platform 110. The multi-modal sensor data may include at least two types of sensor data (e.g., camera and LIDAR data). In some implementations, autonomous platform 110 may utilize the sensor data 204 for sensors that are remote from (e.g., offboard) autonomous platform 110. This may include, for example, sensor data 204 captured by a different autonomous platform 110.

Map data 210 may describe an environment in which autonomous platform 110 was, is, or will be located. Map data 210 may provide information about an environment or a geographic area (e.g., environment 100). For example, map data 210 may provide information regarding the identity and location of different travel ways (e.g., roadways), travel way segments (e.g., road segments), buildings, or other items or objects (e.g., lampposts, crosswalks, curbs); the location and directions of boundaries or boundary markings (e.g., the location and direction of traffic lanes, parking lanes, turning lanes, bicycle lanes, other lanes); traffic control data (e.g., the location and instructions of signage, traffic lights, other traffic control devices); obstruction information (e.g., temporary or permanent blockages); event data (e.g., road closures/traffic rule alterations due to parades, concerts, sporting events); nominal vehicle path data (e.g., indicating an ideal vehicle path such as along the center of a certain lane); or any other map data that provides information that assists an autonomous platform 110 in understanding its surrounding environment and its relationship thereto. Map data 210 may include ground height information (e.g., terrain mapping). Map data 210 may include high-definition map information. Map data 210 may include sparse map data (e.g., lane graphs). Sensor data 204 may be fused with or used to update map data 210 in real-time or offline.

Route data 211 may describe one or more goal locations to which the autonomous vehicle is navigating. A route may include a path that includes one or more goal locations. A goal location may be indicated by a map coordinate (e.g., longitude, latitude, or other coordinate system for a map), an address, a vector A goal location may correspond to a position on a roadway, such as a position within a lane. A goal location may be selected from a continuous or effectively continuous distribution of positions in space or may be selected from a discrete set of positions. For instance, a vector-based map object may provide a continuous distribution of positions from which to select a goal. A raster-based map object may provide an effectively continuous distribution of positions from which to select a goal, subject to the resolution of the map object. A graph-based map object with a number of nodes representing discrete lane positions may provide a discrete distribution of positions from which to select a goal.

Autonomy systems 200 may process route data 211 to navigate a route. For instance, autonomy systems 200 may process route data 211 to generate instructions for navigating to a next goal location. The instructions for navigating may be explicit, such as designated points at which the vehicle is to exit a highway to enter a surface street. The instructions for navigating may be implicit, such as by encoding the instructions as costs used to bias inherent planning decisions of the vehicle to follow the route.

Localization system 230 may provide an autonomous platform 110 with an understanding of its location and orientation in an environment. In some examples, localization system 230 may support one or more other subsystems of autonomy system 200, such as by providing a unified local reference frame for performing, e.g., perception operations, planning operations, or control operations.

Localization system 230 may determine a current position of autonomous platform 110. A current position may include a global position (e.g., respecting a georeferenced anchor) or relative position (e.g., respecting objects in the environment). The localization system 230 may generally include or interface with any device or circuitry for analyzing a position or change in position of an autonomous platform 110 (e.g., autonomous ground-based vehicle). For example, the localization system 230 may determine position by using one or more of: inertial sensors (e.g., inertial measurement unit(s)), a satellite positioning system, radio receivers, networking devices (e.g., based on IP address), triangulation or proximity to network access points or other network components (e.g., cellular towers, Wi-Fi access points), or other suitable techniques. The position of autonomous platform 110 may be used by various subsystems of the autonomy system 200 or provided to a remote computing system (e.g., using the communication interface(s) 206).

In some implementations, the localization system 230 may register relative positions of elements of a surrounding environment of an autonomous platform 110 with recorded positions in the map data 210. For instance, the localization system 230 may process the sensor data 204 (e.g., LIDAR data, RADAR data, camera data) for aligning or otherwise registering to a map of the surrounding environment (e.g., from the map data 210) to understand the position of autonomous platform 110 within that environment. Accordingly, in some implementations, autonomous platform 110 may identify its position within the surrounding environment (e.g., across six axes) based on a search over the map data 210. In some implementations, given an initial location, the localization system 230 may update the position of autonomous platform 110 with incremental re-alignment based on recorded or estimated deviations from the initial location. In some implementations, a position may be registered within the map data 210.

In some implementations, the map data 210 may include a large volume of data subdivided into geographic tiles, such that a desired region of a map stored in the map data 210 may be reconstructed from one or more tiles. For instance, a plurality of tiles selected from the map data 210 may be stitched together by the autonomy system 200 based on a position obtained by the localization system 230 (e.g., a number of tiles selected in the vicinity of the position).

In some implementations, the localization system 230 may determine positions (e.g., relative or absolute) of one or more attachments or accessories for an autonomous platform 110. For instance, an autonomous platform 110 may be associated with a cargo platform, and the localization system 230 may provide positions of one or more points on the cargo platform. For example, a cargo platform may include a trailer or other device towed or otherwise attached to or manipulated by an autonomous platform 110, and the localization system 230 may provide for data describing the position (e.g., absolute, relative) of autonomous platform 110 as well as the cargo platform. Such information may be obtained by the other autonomy systems to help operate autonomous platform 110.

The autonomy system 200 may include the perception system 240, which may allow an autonomous platform 110 to detect, classify, and track objects in its environment. Environmental features or objects perceived within an environment may be those within the field of view of sensors 202 or predicted to be occluded from sensors 202. This may include object(s) not in motion or not predicted to move (static objects) or object(s) in motion or predicted to be in motion (dynamic objects).

The perception system 240 may determine one or more states (e.g., current or past state(s)) of one or more objects that are within a surrounding environment of an autonomous platform 110. For example, state(s) may describe (e.g., for a given time, time period) an estimate of a current or past location of an object (also referred to as position); current or past speed/velocity; current or past acceleration; current or past heading; current or past orientation; size/footprint (e.g., as represented by a bounding shape, object highlighting); classification (e.g., pedestrian class vs. vehicle class vs. bicycle class); the uncertainties associated therewith; other state information; or any combination thereof. In some implementations, the perception system 240 may determine the state(s) using one or more algorithms or machine-learned models configured to identify/classify objects based on inputs from sensors 202. The perception system may use different modalities of the sensor data 204 to generate a representation of the environment to be processed by the one or more algorithms or machine-learned models. In some implementations, state(s) for one or more identified or unidentified objects may be maintained and updated over time as autonomous platform 110 continues to perceive or interact with the objects (e.g., maneuver with or around, yield to). In this manner, the perception system 240 may provide an understanding about a current state of an environment (e.g., including the objects therein) informed by a record of prior states of the environment (e.g., including movement histories for the objects therein). Such information may be output as perception data 245. Perception data 245 may be used by various other systems of autonomous platform 110 (e.g., localization system 230, planning system 250) as it plans its motion through the environment.

The autonomy system 200 may include the planning system 250, which may be configured to determine how autonomous platform 110 is to interact with and move within its environment. The planning system 250 may determine one or more motion plans for an autonomous platform 110. A motion plan may include one or more trajectories (e.g., motion trajectories) that indicate a path for an autonomous platform 110 to follow. A trajectory may be of a certain length or time range. A motion trajectory may be defined by one or more waypoints (with associated coordinates). The waypoint(s) may be future location(s) for autonomous platform 110. The motion plans may be continuously generated, updated, and considered by the planning system 250.

The motion planning system 250 may determine a strategy for autonomous platform 110. A strategy may include a set of discrete decisions (e.g., yield to actor, reverse yield to actor, merge, lane change) that autonomous platform 110 makes. The strategy may be selected from a plurality of potential strategies. The selected strategy may be a lowest cost strategy as determined by one or more cost functions. The cost functions may, for example, evaluate the probability of a collision with an object.

The planning system 250 may determine a desired trajectory for executing a strategy. For instance, the planning system 250 may obtain one or more trajectories for executing one or more strategies. The planning system 250 may evaluate trajectories or strategies (e.g., with scores, costs, rewards, constraints) and rank them. For instance, the planning system 250 may use forecasting output(s) that indicate interactions (e.g., proximity, intersections) between trajectories for autonomous platform 110 and one or more objects to inform the evaluation of candidate trajectories or strategies for autonomous platform 110. In some implementations, the planning system 250 may utilize static cost(s) to evaluate trajectories for autonomous platform 110 (e.g., “avoid lane boundaries,” “minimize jerk,” etc.). Additionally, or alternatively, the planning system 250 may utilize dynamic cost(s) to evaluate the trajectories or strategies for autonomous platform 110 based on forecasted outcomes for the current operational scenario (e.g., forecasted trajectories or strategies leading to interactions between actors, forecasted trajectories or strategies leading to interactions between actors and autonomous platform 110). The planning system 250 may rank trajectories based on one or more static costs, one or more dynamic costs, or a combination thereof. The planning system 250 may select a motion plan (and a corresponding trajectory) based on a ranking of a plurality of candidate trajectories. In some implementations, the planning system 250 may select a highest ranked candidate, or a highest ranked feasible candidate.

The planning system 250 may then validate the selected trajectory against one or more constraints before the trajectory is executed by autonomous platform 110.

To help with its motion planning decisions, the planning system 250 may be configured to perform a forecasting function. The planning system 250 may forecast future state(s) of environment 100. This may include forecasting the future state(s) of other actors in the environment. In some implementations, the planning system 250 may forecast future state(s) based on current or past state(s) (e.g., as developed or maintained by the perception system 240). In some implementations, future state(s) may be or include one or more forecasted trajectories (e.g., positions over time) of the objects in the environment, such as other actors. In some implementations, one or more of the future state(s) may include one or more probabilities associated therewith (e.g., marginal probabilities, conditional probabilities). For example, the one or more probabilities may include one or more probabilities conditioned on the strategy or trajectory options available to autonomous platform 110. Additionally, or alternatively, the probabilities may include probabilities conditioned on trajectory options available to one or more other actors.

In some implementations, the planning system 250 may perform interactive forecasting. The planning system 250 may determine a motion plan for an autonomous platform 110 with an understanding of how forecasted future states of the environment may be affected by execution of one or more candidate motion plans.

By way of example, with reference again to FIG. 1, autonomous platform 110 may determine candidate motion plans corresponding to a set of platform trajectories 112A-C that respectively correspond to the first actor trajectories 122A-C for the first actor 120, trajectories 132 for the second actor 130, and trajectories 142 for the third actor 140 (e.g., with respective trajectory correspondence indicated with matching line styles). Autonomous platform 110 may evaluate each of the potential platform trajectories and predict its impact on the environment.

For example, autonomous platform 110 (e.g., using its autonomy system 200) may determine that a platform trajectory 112A would move autonomous platform 110 more quickly into the area in front of the first actor 120 and is likely to cause the first actor 120 to decrease its forward speed and yield more quickly to autonomous platform 110 in accordance with a first actor trajectory 122A.

Additionally, or alternatively, autonomous platform 110 may determine that a platform trajectory 112B would move autonomous platform 110 gently into the area in front of the first actor 120 and, thus, may cause the first actor 120 to slightly decrease its speed and yield slowly to autonomous platform 110 in accordance with a first actor trajectory 122B.

Additionally, or alternatively, autonomous platform 110 may determine that a platform trajectory 112C would cause the autonomous vehicle to remain in a parallel alignment with the first actor 120 and, thus, the first actor 120 is unlikely to yield any distance to autonomous platform 110 in accordance with first actor trajectory 122C.

Based on comparison of the forecasted scenarios to a set of desired outcomes (e.g., by scoring scenarios based on a cost or reward), the planning system 250 may select a motion plan (and its associated trajectory) in view of the interaction of autonomous platform 110 with the environment 100. In this manner, for example, autonomous platform 110 may achieve at least a technical improvement that interleaves its forecasting and motion planning functionality.

To implement selected motion plan(s), the autonomy system 200 may include a control system 260 (e.g., a vehicle control system). Generally, the control system 260 may provide an interface between the autonomy system 200 and the platform control devices 212 for implementing the strategies and motion plan(s) generated by the planning system 250. For instance, control system 260 may implement the selected motion plan/trajectory to control the motion of autonomous platform 110 through its environment by following the selected trajectory (e.g., the waypoints included therein). The control system 260 can, for example, translate a motion plan into instructions for the appropriate platform control devices 212 (e.g., acceleration control, brake control, steering control). By way of example, the control system 260 may translate a selected motion plan into instructions to adjust a steering component (e.g., a steering angle) by a certain number of degrees, apply a certain magnitude of braking force, increase/decrease speed In some implementations, the control system 260 may communicate with the platform control devices 212 through communication channels including, for example, one or more data buses (e.g., controller area network (CAN)), onboard diagnostics connectors (e.g., OBD-II), or a combination of wired or wireless communication links. The platform control devices 212 may send or obtain data, messages, signals to or from the autonomy system 200 (or vice versa) through the communication channel(s).

The autonomy system 200 may receive, through communication interface(s) 206, assistive signal(s) from remote assistance system 270. Remote assistance system 270 may communicate with the autonomy system 200 over a network (e.g., as a remote system 160 over network 170). In some implementations, the autonomy system 200 may initiate a communication session with the remote assistance system 270. For example, the autonomy system 200 may initiate a session based on or in response to a trigger. In some implementations, the trigger may be an alert, an error signal, a map feature, a request, a location, a traffic condition, a road condition

After initiating the session, the autonomy system 200 may provide context data to the remote assistance system 270. The context data may include sensor data 204 and state data of autonomous platform 110. For example, the context data may include a live camera feed from a camera of autonomous platform 110 and the current speed of autonomous platform 110. An operator (e.g., human operator) of the remote assistance system 270 may use the context data to select one or more assistive signals. The assistive signal(s) may provide values or adjustments for various operational parameters or characteristics for the autonomy system 200. For instance, the assistive signal(s) may include way points (e.g., a path around an obstacle, lane change), velocity or acceleration profiles (e.g., speed limits), relative motion instructions (e.g., convoy formation), operational characteristics (e.g., use of auxiliary systems, reduced energy processing modes), or other signals to assist the autonomy system 200.

Autonomy system 200 may use the assistive signal(s) for input into one or more autonomy subsystems for performing autonomy functions. For instance, the planning system 250 may receive the assistive signal(s) as an input for generating a motion plan. For example, assistive signal(s) may include constraints for generating a motion plan. Additionally, or alternatively, assistive signal(s) may include cost or reward adjustments for influencing motion planning by the planning system 250. Additionally, or alternatively, assistive signal(s) may be considered by the autonomy system 200 as suggestive inputs for consideration in addition to other received data (e.g., sensor inputs).

The autonomy system 200 may be platform agnostic, and the control system 260 may provide control instructions to platform control devices 212 for a variety of different platforms for autonomous movement (e.g., a plurality of different autonomous platform 110s fitted with autonomous control systems). This may include a variety of different types of autonomous vehicles (e.g., sedans, vans, SUVs, trucks, electric vehicles, combustion power vehicles) from a variety of different manufacturers/developers that operate in various different environments and, in some implementations, perform one or more vehicle services.

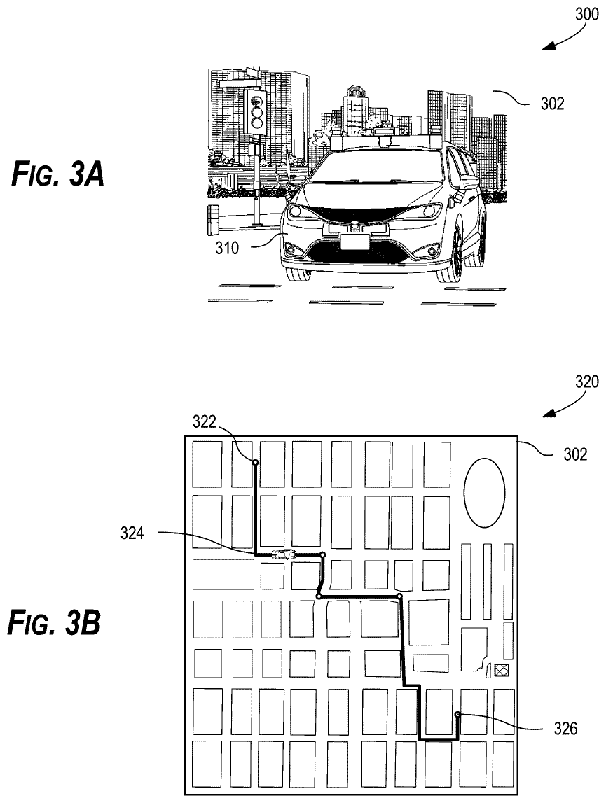

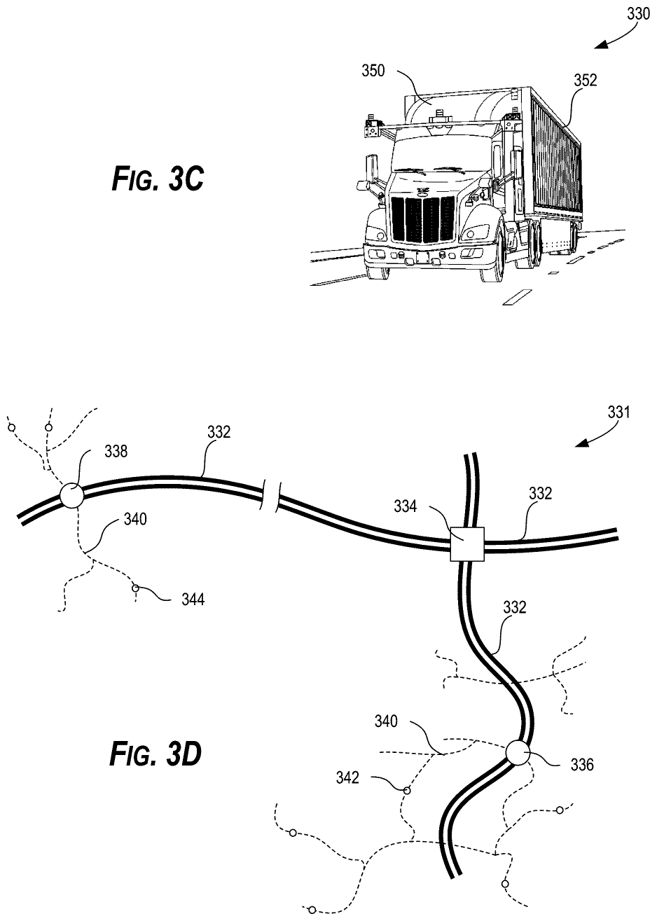

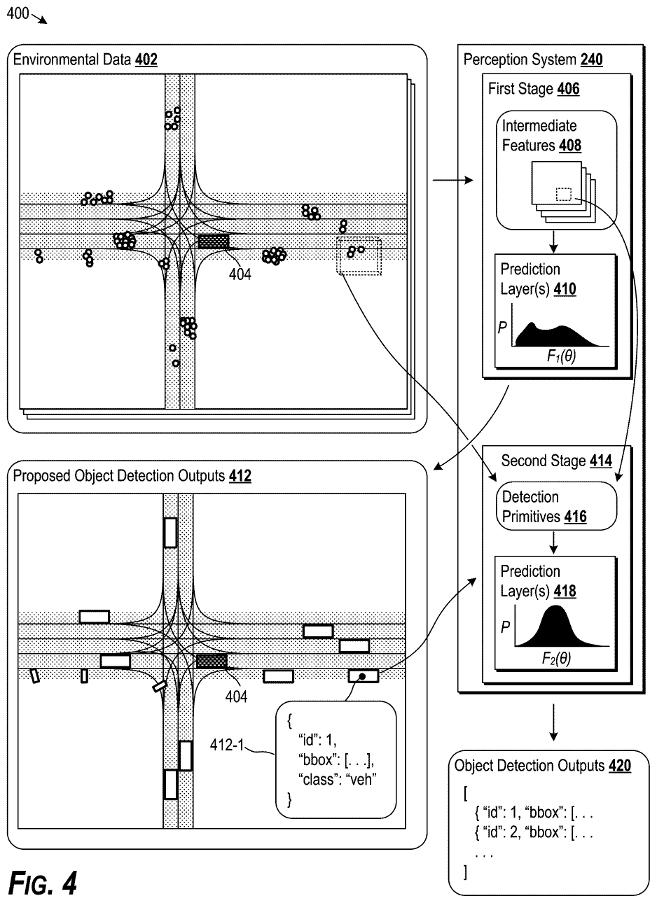

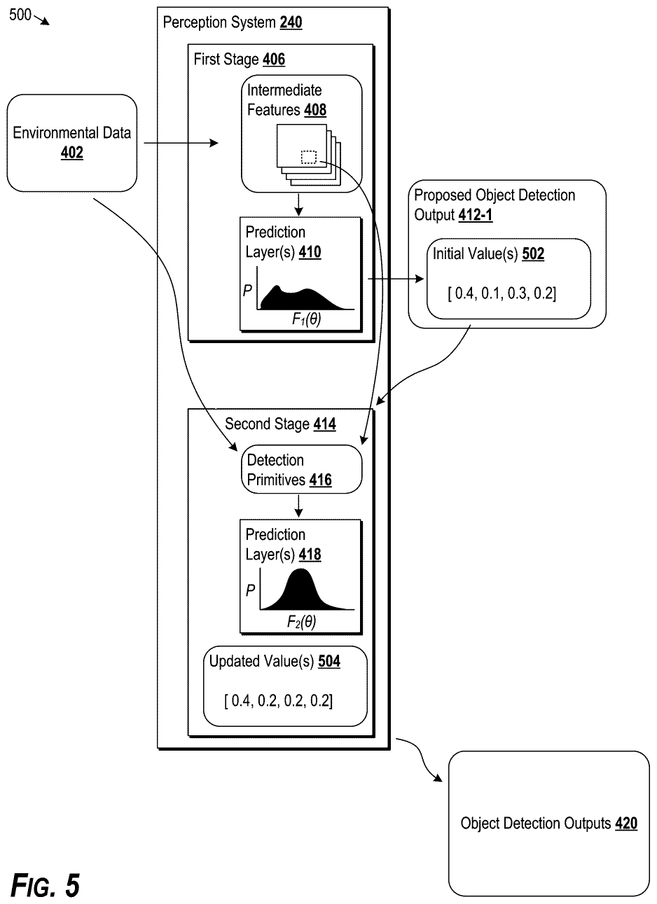

For example, with reference to FIG. 3A, an operational environment 300 may include a dense environment 302. An autonomous platform 110 may include an autonomous vehicle 310 controlled by the autonomy system 200. In some implementations, the autonomous vehicle 310 may be configured for maneuverability in dense environment 302, such as with a configured wheelbase or other specifications. In some implementations, the autonomous vehicle 310 may be configured for transporting cargo or passengers. In some implementations, the autonomous vehicle 310 may be configured to transport numerous passengers (e.g., a passenger van, a shuttle, a bus). In some implementations, the autonomous vehicle 310 may be configured to transport cargo, such as large quantities of cargo (e.g., a truck, a box van, a step van) or smaller cargo (e.g., food, personal packages).

With reference to FIG. 3B, a selected overhead view 320 of the dense environment 302 is shown overlaid with an example trip/service between a first location 322 and a second location 326. The example trip/service may be assigned, for example, to an autonomous vehicle 324 by a remote computing system. The autonomous vehicle 324 may be, for example, the same type of vehicle as autonomous vehicle 310. The example trip/service may include transporting passengers or cargo between the first location 322 and the second location 326. In some implementations, the example trip/service may include travel to or through one or more intermediate locations, such as to onload or offload passengers or cargo. In some implementations, the example trip/service may be prescheduled (e.g., for regular traversal, such as on a transportation schedule). In some implementations, the example trip/service may be on-demand (e.g., as requested by or for performing a taxi, rideshare, ride hailing, courier, delivery service).

With reference to FIG. 3C, in another example, an operational environment may include an open travel way environment 330. An autonomous platform 110 may include an autonomous vehicle 350 controlled by the autonomy system 200. This may include an autonomous tractor for an autonomous truck. In some implementations, the autonomous vehicle 350 may be configured for high payload transport (e.g., transporting freight or other cargo or passengers in quantity), such as for long distance, high payload transport. For instance, the autonomous vehicle 350 may include one or more cargo platform attachments such as a trailer 352. Although depicted as a towed attachment in FIG. 3C, in some implementations one or more cargo platforms may be integrated into (e.g., attached to the chassis of) the autonomous vehicle 350 (e.g., as in a box van, step van).

With reference to FIG. 3D, a selected overhead view 331 of open travel way environment 330 is shown, including travel ways 332, an interchange 334, transfer hubs 336 and 338, access travel ways 340, and locations 342 and 344. In some implementations, an autonomous vehicle (e.g., the autonomous vehicle 310 or the autonomous vehicle 350) may be assigned an example trip/service to traverse the one or more travel ways 332 (optionally connected by the interchange 334) to transport cargo between the transfer hub 336 and the transfer hub 338. For instance, in some implementations, the example trip/service includes a cargo delivery/transport service, such as a freight delivery/transport service. The example trip/service may be assigned by a remote computing system. In some implementations, the transfer hub 336 may be an origin point for cargo (e.g., a depot, a warehouse, a facility) and the transfer hub 338 may be a destination point for cargo (e.g., a retailer). However, in some implementations, the transfer hub 336 may be an intermediate point along an ultimate journey of a cargo item between its respective origin and its respective destination. For instance, an origin of a cargo item may be situated along the access travel ways 340 at the location 342. The cargo item may accordingly be transported to transfer hub 336 (e.g., by a human-driven vehicle, by the autonomous vehicle 310) for staging. At the transfer hub 336, various cargo items may be grouped or staged for longer distance transport over the travel ways 332.

In some implementations of an example trip/service, a group of staged cargo items may be loaded onto an autonomous vehicle (e.g., the autonomous vehicle 350) for transport to one or more other transfer hubs, such as the transfer hub 338. For instance, although not depicted, it is to be understood that the open travel way environment 330 may include more transfer hubs than the transfer hubs 336 and 338 and may include more travel ways 332 interconnected by more interchanges 334. A simplified map is presented here for purposes of clarity only. In some implementations, one or more cargo items transported to the transfer hub 338 may be distributed to one or more local destinations (e.g., by a human-driven vehicle, by the autonomous vehicle 310), such as along the access travel ways 340 to the location 344. In some implementations, the example trip/service may be prescheduled (e.g., for regular traversal, such as on a transportation schedule). In some implementations, the example trip/service may be on-demand (e.g., as requested by or for performing a chartered passenger transport or freight delivery service).

To improve the operation of autonomous platforms, such as an autonomous vehicle (e.g., autonomous platform 110) controlled at least in part using autonomy system 200 (e.g., the autonomous vehicles 310 or 350), example aspects of the present disclosure provide improved perception systems and techniques.

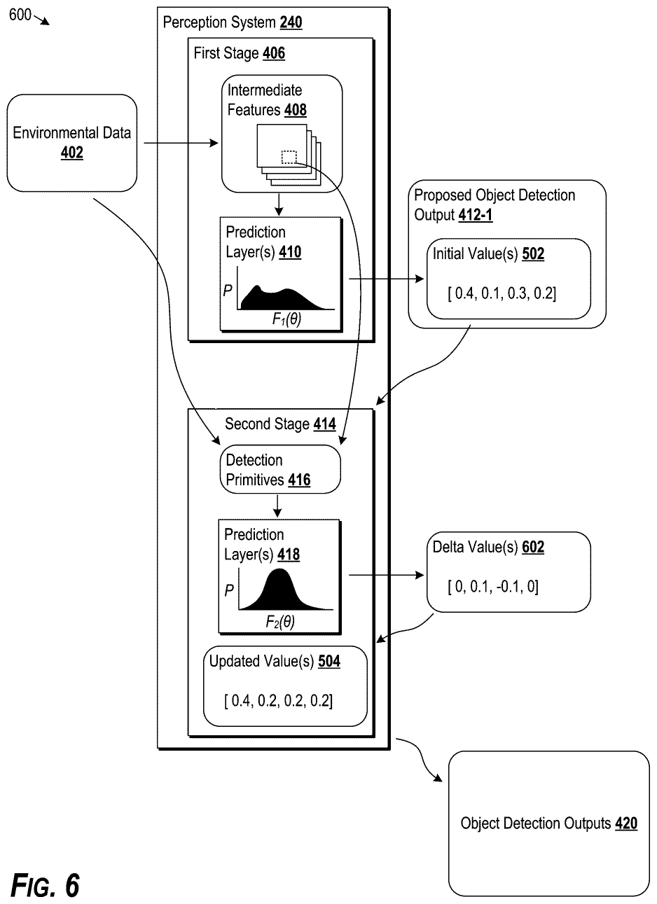

FIG. 4 is a block diagram 400 of aspects of an example system for executing perception system 240 according to example aspects of the present disclosure. Perception system 240 may ingest environmental data 402 surrounding a position 404 of the ego vehicle. A first stage 406 of perception system 240 may generate intermediate features 408 that characterize environmental data 402. First stage 406 may process intermediate features 408 using prediction layers 410 to generate one or more prediction values for proposed object detection outputs 412. An example proposed object detection output 412-1 may include, for example, a bounding boxes for proposed object detections and initial predictions for attribute values (e.g., class values, logits for class values). A second stage 414 of perception system 240 may operate to refine the initial predictions by extracting detection primitives 416 from one or more of environmental data 402 or latent features 408. Second stage 414 may process detection primitives 416 using prediction layers 418 to generate one or more updated or refined prediction values based on the initial predictions in proposed object detection outputs 412. Based on the updated or refined prediction values, perception system 240 may output object detection outputs 420.

Environmental data 402 may include any one or multiple modalities of sensor data 204, map data 210, or other data describing an environment of the autonomous vehicle. In an example, environmental data 402 may include point cloud data (e.g., lidar) and image data (e.g., camera). Environmental data 402 may include sensor data 204 registered to map data 210 (e.g., registered using localization system 230).

First stage 406 may be or include hardware or software elements operable to execute operations that propose object detections for further refinement by second stage 414. First stage 406 may include software elements that are compiled or interpreted, loaded into memory, and executed by a processor to execute the operations. First stage 406 may be implemented on at least a portion of hardware resources dedicated to execution of first stage 406 (e.g., allocated memory, allocated processors or processor threads). For instance, one or more components of first stage 406 may be loaded into a designated allocation of memory for efficient retrieval during one or more cycles of perception system 240. First stage 406 may share hardware resources with other components of autonomy system 200, such as with second stage 414.

First stage 406 may receive environmental data 402 as input. First stage 406 may process the input environmental data 402 to generate intermediate features 408.

Intermediate features 408 may be or include latent features that characterize environmental data 402. Latent features may include outputs of a machine-learned encoder configured to encode at least a portion of environmental data 402 into condensed feature representations thereof. A feature representation may include a tensor of numerical values. For instance, a machine-learned encoder may generate image features that represent aspects of image data, lidar features that represent aspects of lidar data, map features that represent aspects of map data, or fusion features that jointly represent aspects of one or more modalities of data from environmental data 402.

Intermediate features 408 may include outputs of filters, classifiers, or other operations of first stage 406 applied to environmental data 402. Intermediate features 408 may not be latent and may be human interpretable features amenable to inspection. Intermediate features 408 may include, for instance, a roadway type indicator (e.g., surface street or highway) retrieved from map data, an intersection type indicator (e.g., all-way stop) retrieved from map data, a weather state retrieved from a weather data service or inferred based on sensor data, or other contextual information.

Prediction layers 410 may be or include one or more processing components applied to intermediate features 408 that include one or more machine-learned model architectures. Prediction layers 410 may include output heads of a machine-learned model that are connected to and receive input from a machine-learned encoder that generates one or more of intermediate features 408. Prediction layers 410 may receive intermediate features 408 or environmental data 402 as input. Prediction layers 410 may receive both intermediate features 408 and environmental data 402 as input to perform inference jointly over raw inputs as well as intermediate features.

First stage 406 may generate proposed object detection outputs 412 using prediction layers 410. For instance, first stage 406 may execute prediction layers 410 to generate output values. An output value may correspond to an attribute of a proposed detected object. For instance, an attribute may be a bounding box dimension, a bounding box location, an object extent, an object type or class, an object heading, an object velocity or other motion value, a lane position, or any other object attribute. The output value may be the attribute value itself or may be a value that corresponds to a likelihood for the attribute (e.g., a logit value associated with the attribute).

For example, a prediction layer may include a classification portion or head that generates scores for a plurality output classes. The score may be an output value. The score may be a logit value. In this manner, for instance, an output value may be a value that corresponds to an initial likelihood that an attribute of the proposed detected object has a value corresponding to a particular class.

For example, a prediction layer may include a regression portion or head that computes a regressed output value. A regression portion may compute a numerical value directly as a product of one or more linear or nonlinear operations rather than selecting a likely candidate value from among a plurality of candidate values. An example regressed value may include a dimension value or measurement associated with a proposed detected object. An example measurement value may include a boundary associated with the proposed detected object. An example measurement value may include a velocity associated with the proposed detected object. In this manner, for instance, the output value may be an attribute value itself.

Similarly, a prediction layer can output a classification result. For instance, a classification result can include a flag value indicating whether an object is near a roadway.

Proposed object detection outputs 412 may include or be based on the output values of prediction layers 410. In an example, a proposed object detection output 412-1 indicates a proposed detected object in the environment. For instance, proposed object detection output 412-1 may indicate that a proposed detected object exists at a location. A detection output of first stage 406 may be “proposed” for refinement by second stage 414. As such, proposed object detection outputs 412 may be configured for high recall while deferring high precision evaluate to second stage 414.

A proposed object detection output 412-1 may indicate initial values for one or more attributes of the proposed detected object. A proposed object detection output 412-1 may include the attribute values for one or more attributes of the proposed detected object. A proposed object detection output 412-1 may include logit values for one or more attributes of the proposed detected object. A proposed object detection output 412-1 may include a value that indicates a likelihood for one or more attributes of the proposed detected object.

For instance, a proposed object detection output 412-1 may include initial bounding box dimensions and a distribution over object classes for a particular object. For instance, an example proposed object detection output 412-1 may be represented as follows:

```
{
  “id”: 1,
  “bbox”: [. . .],
  “dist”: [ .4, .1, .3, .2]
}
```

where the tensor stored in association with the “dist” attribute is indexed to match a set of possible object classes for the object.

An example bounding box representation includes a tensor indicating a length, a width, a height, and a keypoint location. One or more of the length, width, or height may be a vector quantity indicating an orientation of the box, or the orientation may be stored in a dedicated dimension and by convention or explicitly associated with one of the dimensions. A keypoint may be a position of the box that is used to register the box in space, such as a center point or a corner point. An example keypoint is a corner point, such as a lower corner point. Keypoint location may be defined in three dimensions. An example bounding box representation is a tensor containing: a first dimension vector indicating a measurement and an orientation of the measured dimension, a second dimension value representing a measurement orthogonal to the first dimension, a third dimension value representing a measurement orthogonal to the first dimension and the second dimension, and a three-dimensional keypoint vector. An example bounding box representation is a tensor containing: a first dimension vector indicating a measurement and an orientation of the measured dimension, a second dimension value representing a measurement orthogonal to the first dimension, a third dimension value representing a measurement orthogonal to the first dimension and the second dimension, a two-dimensional keypoint vector indicating a planar position (e.g., a ground plane), and a height or z-offset of the keypoint.

First stage 406 may generate predictions for multiple locations in an environment for a given cycle of perception system 240. For example, perception system 240 may execute periodically (e.g., at 10 Hz) to refresh a current set of object detections based on current sensor data. First stage 406 may execute each cycle to ingest sensor data. First stage 406 may generate, for a given cycle, predictions for each of a plurality of proposal positions in a representation of the environment. For example, a representation of the environment may include a birds-eye-view representation, a range view representation, or some other representation (e.g., a latent or implicit representation).

A position in the representation may be defined using an indexing parameter for the representation. For instance, a position in a raster representation may correspond to a pixel location. A position in a serialized data format may correspond to one or more portions of a serialized sequence that corresponds to a given location in an environment. A position in a representation of point-based data may be indexed by a position coordinate of the point(s). First stage 406 may generate a prediction at each location to indicate whether an object is proposed to be present at that location (e.g., for each pixel, each sequence location).

Locations may be grouped. For instance, a location in an environment may correspond to an area or region of the environment. An area in a raster representation may correspond to a group of pixels, such as a patch. First stage 406 may generate a prediction for each patch that indicates whether an object is proposed to be present at that patch location (e.g., that at least a portion of an object is represented in the patch). Similarly, ranges of other indexing parameters may be used to process groups of a representation together.

In this manner, for instance, first stage 406 may generate proposals for subsequent refinement for a plurality of predetermined positions in an environment. These positions may be selected to coarsely cover a broad region to optimize allocation of computing resources to provide strong recall over a broad range of detection. Second stage 414 may be configured to generate more precise predictions, but only over local regions surrounding the proposed detections. With this more focused scope, second stage 414 may more effectively allocate computational resources (e.g., memory, processor cycles) to increase precision and detection sensitivity in localized areas. The precision of the refinement stage may not demand any increased computational effort by the proposal stage. In this manner, for instance, example implementations of the present disclosure may provide more efficient computation over an increased range of detections.

Second stage 414 may be or include hardware or software elements operable to execute operations that refine object detections proposed by first stage 406. Second stage 414 may include software elements that are compiled or interpreted, loaded into memory, and executed by a processor to execute the operations. Second stage 414 may be implemented on at least a portion of hardware resources dedicated to execution of second stage 414 (e.g., allocated memory, allocated processors or processor threads). For instance, one or more components of second stage 414 may be loaded into a designated allocation of memory for efficient retrieval during one or more cycles of perception system 240. Second stage 414 may share hardware resources with other components of autonomy system 200, such as with first stage 406.

Second stage 414 may retrieve detection primitives 416 to assist in refining the proposals from first stage 406.

Detection primitives 416 may include raw data from environmental data 402. Detection primitives 416 may include data from intermediate features 408, such as latent feature data. Detection primitives 416 may be obtained from any portion of first stage 406 or any input to first stage 406. Detection primitives 416 may be obtained from other data that is not input to first stage 406. Example detection primitives 416 include point-cloud data, such as lidar or radar data, which may be represented in a birds-eye-view representation. Example detection primitives 416 include image data or image features, which may be projected into a birds-eye-view representation. Example detection primitives 416 include features from range view cameras and lateral view cameras.

Detection primitives 416 may be “box-focused.” A box-focused technique can focus computation on regions of an environment surrounding proposed detection boxes instead of spreading computation evenly across all locations in the environment, which may contain large areas of off-road locations that may not be relevant to a perception task for driving.

Detection primitives 416 may be focused on an area around a proposed detected object, such as an area defined based on a predicted bounding box or other boundary associated with the proposed object. For instance, second stage 414 may extract detection primitives 416 using a proposed location or extent of an object. For instance, keypoint location may be used to extract an area of detection primitives. The extracted area may be a fixed size (e.g., to conform to an input dimension of a component of second stage 414 or to conform to an allocated memory size for efficient computation). The extracted area may be adapted in size for each object proposal. For instance, a bounding box dimension or extent may be used to extract the area. By extracting a smaller portion of the environment to examine, second stage 414 may increase a precision associated with its refinement mechanism as compared to a precision of first stage 406 that is decoupled from a computational cost of second stage 414 as compared to first stage 406.

In this manner, for instance, detection primitives 416 may be or provide local context for a particular proposed object detection. Local context data may include, for a location in the environment associated with a proposed detected object, a portion of environmental data 402 or a portion of latent feature data generated by first stage 406.

Detection primitives 416 may flow to second stage 414 along learned connections within perception 240. For instance, a neural architecture search may be performed with learnable parameters connecting second stage 414 to one or more upstream data sources, such as raw data from environmental data 402 or intermediate hidden states within or outputs from first stage 406. During training of all or part of perception system 240, these learnable parameters may be updated to improve a performance (e.g., decrease a loss). In this manner, for instance, perception system 240 may learn to extract the most useful detection primitives for detection refinement.

Such learned connections may be conditioned on attributes of environmental data 402. For instance, based on weather or sensor operation states, raw data from an individual sensor (e.g., an image sensor) may provide strong signals helpful for object detection refinement. In other contexts, the same sensor may be obscured or suboptimally performant (e.g., in inclement weather), such that the best signals available are further downstream in the processing pipeline, such as a latent feature of intermediate features 408, which may fuse information from multiple modalities. Similarly, in some contexts, intermediate features 408 that encapsulate significant contextual information in a small amount of data (e.g., classification outputs) may be obtained with high confidence, while in other contexts the same features may be obtained with lower confidence. Learned connections to second stage 414 may be conditioned on a confidence of the underlying feature data, so that particular features may have greater influence when they are obtained with higher confidence.

Second stage 414 may apply a filtering mechanism to focus its refinements on the best proposals. An example filtering mechanism includes non-maximal suppression (“NMS”). NMS may include eliminating redundant or overlapping bounding boxes by selecting only the most relevant ones. NMS may include filtering boxes based on a confidence threshold and sorting the remaining boxes by confidence scores. The box with the highest score may be selected as a reference and any other boxes that overlap significantly with the reference (e.g., measured by Intersection over Union, or “IoU”) may be suppressed. In this manner, for instance, second stage 414 may remove highly-probable false positives.

Prediction layers 418 may be or include one or more processing components applied to detection primitives 416 and a proposed object detection output 412-1 that include one or more machine-learned model architectures. Prediction layers 418 may include output heads of a machine-learned model that are connected to and receive input from a machine-learned encoder that ingest detection primitives 416. Prediction layers 418 may receive detection primitives 416 as input.

Prediction layers 418 may include, in an example, a feedforward neural network. An example feedforward neural network is a multilayer perceptron. The feedforward neural network can include a plurality of layers. The feedforward neural network can include two layers.

Second stage 414 may generate object detection outputs 420 using prediction layers 418. For instance, second stage 414 may execute prediction layers 418 to generate output values. An output value may correspond to an attribute of a proposed detected object. For instance, an attribute may be a bounding box dimension, a bounding box location, an object extent, an object type or class, an object heading, an object velocity or other motion value, a lane position, or any other object attribute. The output value may be the attribute value itself or may be a value that corresponds to a likelihood for the attribute (e.g., a logit value associated with the attribute).

For example, a prediction layer may include a classification portion or head that generates scores for a plurality output classes. The score may be an output value. The score may be a logit value. In this manner, for instance, an output value may be a value that corresponds to an initial likelihood that an attribute of the proposed detected object has a value corresponding to a particular class.

For example, a prediction layer may include a regression portion or head that computes a regressed output value. A regression portion may compute a numerical value directly as a product of one or more linear or nonlinear operations rather than selecting a likely candidate value from among a plurality of candidate values. An example regressed value may include a dimension value or measurement associated with a proposed detected object. An example measurement value may include a boundary associated with the proposed detected object. An example measurement value may include a velocity associated with the proposed detected object. In this manner, for instance, the output value may be an attribute value itself.

Similarly, a prediction layer can output a classification result. For instance, a classification result can include a flag value indicating whether an object is near a roadway.

Object detection outputs 420 may include a data object describing a detected object in the environment. An object detection output may include, for example, an identifier for the object, an object class value, and a boundary of the object. An object detection output may be associated with one or more prior object detections by an object tracker. An object tracker may maintain a record of object detections over time and associate new detections for an object to a record or “track” associated with a particular object. Perception data 245 may be based on object detection outputs 420.

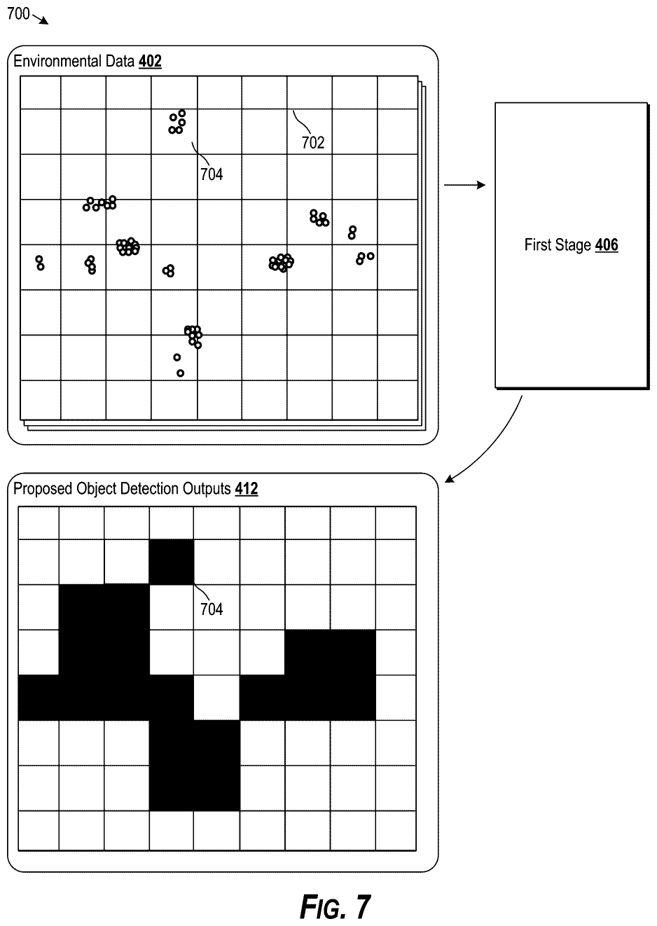

In general, second stage 414 may operate to generate updated values for initial predictions. An example implementation is shown in FIG. 5.

FIG. 5 is a block diagram 500 of aspects of an example system for executing perception system 240 according to example aspects of the present disclosure.

Initial value(s) 502 may include initial prediction values output by prediction layers 410. For instance, these values may correspond to a likelihood for an attribute, a predict measurement value for an attribute, or any other prediction value.

Updated value(s) 504 may be generated by second stage 414 based on an output of prediction layer(s) 418. For instance, upon refinement, second stage 414 may confirm the first and the last initial values while outputting a new value of 0.2 for the second value (replacing 0.1) and a new value of 0.2 for the third value (replacing 0.3).

In general, the updated values may correspond to an increase in likelihood or a decrease in likelihood. For instance, second stage 414 may increase a likelihood associated with a particular attribute because, when refined using more precise local context, more information is available that further confirms the initial prediction value. Second stage 414 may decrease a likelihood associated with a particular attribute because, when refined using more precise local context, more information is available that contradicts or diverges from the initial prediction value.

In this manner, for instance, the updated values may be used to avoid false negatives and suppress false positives. For instance, when operating at a first coarse precision, first stage 406 may emit proposals that have likelihoods that are inaccurately high (e.g., false positive) or inaccurately low (e.g., false negative). In an example of false negative recovery, first stage 406 may output an initial value indicating a low likelihood that a boundary of a proposed detected object is present at the location. Second stage 414 may output an updated value that indicates, as compared to the initial value, a higher likelihood that a boundary of the proposed detected object is present at the location, such that the final object detection outputs 420 indicates an object detected at the location. In an example of false positive suppression, first stage 406 may output an initial value indicating a likelihood that a boundary of a proposed detected object is present at the location. Second stage 414 may output an updated value that indicates, as compared to the initial value, a lower likelihood that a boundary of the proposed detected object is present at the location, such that the final object detection outputs 420 do not indicate any object detected at the location.

Updated value(s) 504 may be output directly from prediction layer(s) 418. Prediction values(s) may alternatively output delta values. Delta values may be overlaid or otherwise composited with the initial values to generate the updated values.

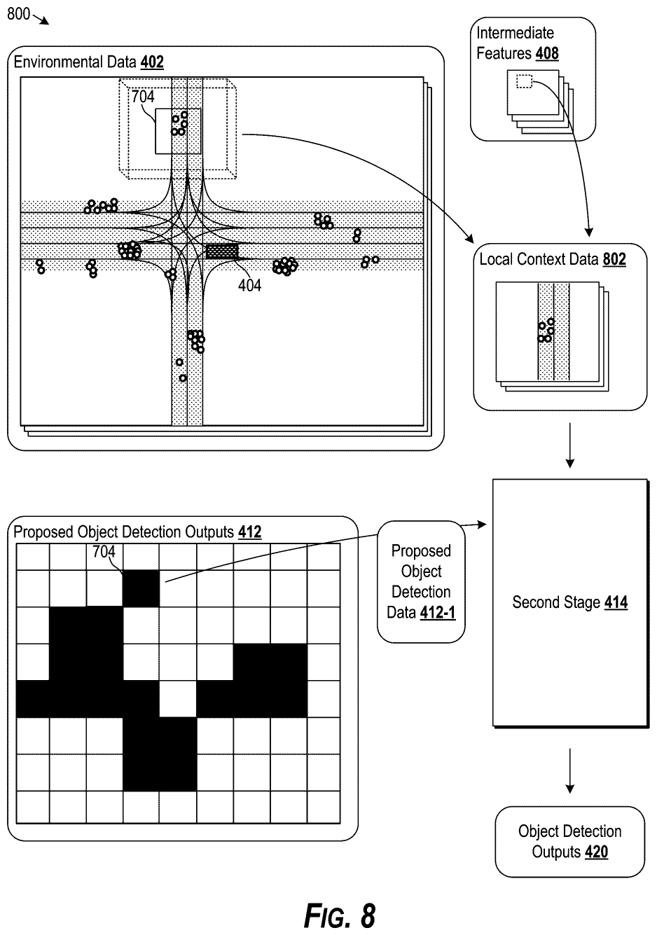

FIG. 6 is a block diagram 600 of aspects of an example system for executing perception system 240 according to example aspects of the present disclosure. Prediction layers 418 may output delta values 602. Delta values 602 may be combined with initial values 502 to obtain updated values 504.

For example, prediction layers 418 may output delta values in a logit space to adjust logit values initially output by prediction layers 410. Prediction layers 418 may regress the delta values using a neural network.

Final classification based on the predictions may be deferred until after the logit values are refined. For example, first stage 406 may generate, for an attribute, initial value(s) 502. Initial value(s) 502 may respectively correspond to a plurality of output classes for classifying a proposed detected object. Second stage 414 may process initial value(s) 502 and local context data from detection primitives 416 to generate delta values 602 for initial values 502. Perception system 240 may generate, based on initial values 502 and delta values 602, updated values 504 that represent a refinement of initial values 502. Perception system 240 may select an output class for the attribute from the plurality of output classes based on updated values 504. In this manner, for instance, perception system 240 may preserve context regarding its estimations over all candidate options until refinement is complete, rather than reaching an initial decision and discarding the relative scores or likelihoods of the other candidates being considered. This can help suppress false positives and avoid false negatives.

Prediction layers 418 may generate delta values to apply to an output of a regression head. Prediction layers 418 may generate a delta value applied to a mean of a regression field. For instance, a regression field may contain multiple values. All values in the field may be refined via translation by adjusting the mean of the field.

In an example, first stage 406 generates a delta value based on an initial value and local context data. Perception system 240 may combine the initial value and the delta value into a combined value. Perception system 240 may generate the updated value based on the combined value. The initial value may indicate an initial value for a measurement associated with the proposed detected object, and the updated prediction value may indicate an updated value for the measurement.

FIG. 7 is a block diagram 700 of aspects of an example system for executing perception system 240 according to example aspects of the present disclosure. First stage 406 may generate predictions for a plurality of positions in the representation of the environment (e.g., based on environmental data 402) that correspond to a bird's eye view grid over the environment, such as grid 702.

A location 704 may correspond to a cell of grid 702. First stage 406 may generate a prediction for each cell to identify which cells might contain objects. For instance, for each cell location, first stage 406 may generate a prediction whether there is a proposed object in the cell. The prediction output may be a negative or a null result if no object is detected in the cell. The output may be a positive or not-null result (e.g., containing data describing a proposed object detection) if an object is proposed to be in the cell. For example, the filled cells in FIG. 7 may represent cells in which an object proposal was generated.

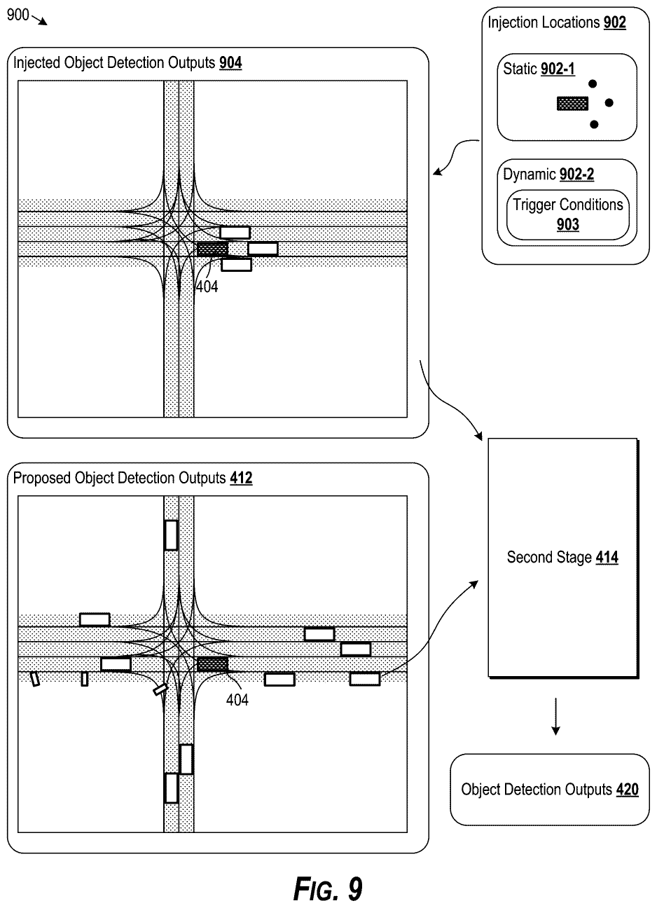

FIG. 8 is a block diagram 800 of aspects of an example system for executing perception system 240 according to example aspects of the present disclosure. As in FIG. 7, the filled cells in proposed object detection results 412 may represent proposal locations in which an object proposal was generated. Second stage 414 may refine a proposal associated with location 704 based on example proposed object detection output 412-1. Based on data identifying or indexing location 704, perception system 240 may index into environmental data 402 or intermediate features 408 to extract local context data 802 and provide local context data 802 to second stage 414 as detection primitives 416.

Local context data 802 may include environmental data that describes a position in the environment corresponding to location 704. Local context data 802 may include latent feature data that describes a position in the environment corresponding to location 704.

Local context data 802 may include data that is a superset of environmental data that describes a position in the environment corresponding to location 704. Local context data 802 may include data that is a superset of latent feature data that describes a position in the environment corresponding to location 704. For instance, local context data 802 may cover a broader region than location 704 to include more nearby context. The size of the region may be fixed or conditional. The extracted area may be a fixed size (e.g., to conform to an input dimension of a component of second stage 414 or to conform to an allocated memory size for efficient computation). The extracted area may be adapted in size for each object proposal. For instance, a bounding box dimension or extent may be used to extract the area.

Local context data 802 may be extracted and processed more granularly than an operating precision of first stage 406. Second stage 414 may process and generate predictions without constraint to the operating precision of first stage 406.

In an example, a recall performance of perception system 240 may be augmented by injecting proposals directly into second stage 414. For instance, a set of positions may be of high interest for a motion planning task (e.g., locations near to the front of the ego vehicle, locations near to a path of the vehicle) or for system validation (e.g., locations in zones of decreased sensor field of view overlap). The refinement task may be seeded with injected proposals that do not original with the organic results from first stage 406. In this manner, for instance, the precision of second stage 414 may be guaranteed to be leveraged to examine at least those injected proposals, without relying on the coarse detection of first stage 406 to first return a result, thereby reducing one possible point of failure.

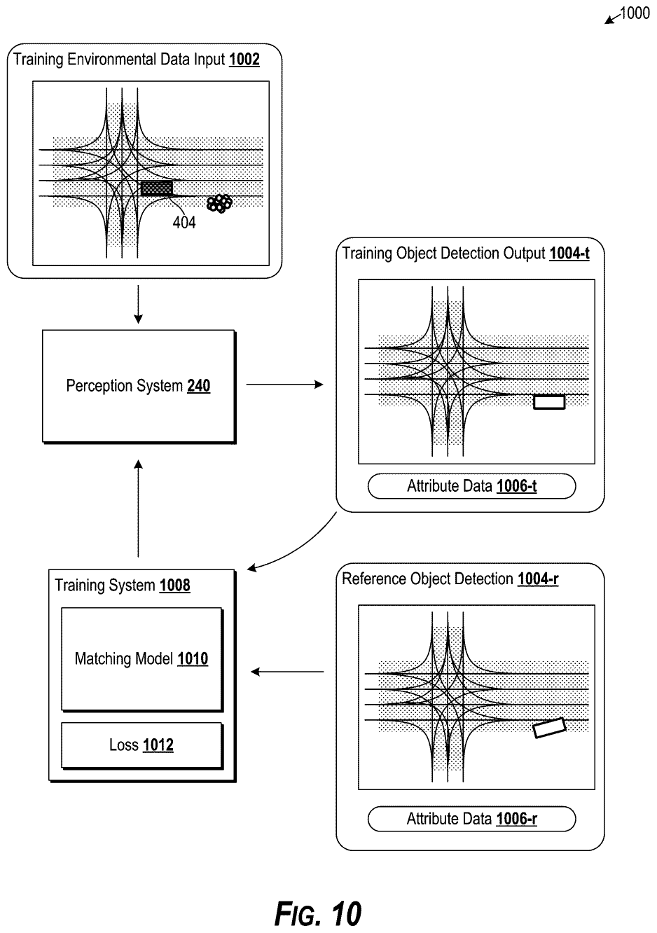

FIG. 9 is a block diagram 900 of aspects of an example system for executing perception system 240 according to example aspects of the present disclosure. Injection locations 902 may define a set of positions that are of interest for examination using second stage 414. Some locations may be statically defined, such as static locations 902-1. Some locations, such as dynamic locations 902-2, may be defined based on one or more trigger conditions 903.

Static injection locations 902-1 may be defined with respect to the ego vehicle. For instance, a static injection location may include areas of high importance for motion planning, emergency maneuvers, or other criteria. For example, static injection locations may include areas near the ego vehicle. Static injection locations may include areas identified based on a ranking of perception error locations. For example, if perception errors occur in a particular location in the field of view of the ego vehicle at a higher rate than other locations, the particular location may be added as an injection location. Static injection locations may include areas identified based on an available quality of sensor data covering the location. For instance, first stage 406 may be more reliable when multiple sensors overlap to provide strongly correlated signals in different modalities. Conversely, it may be more challenging to perform object detection based on sensor data without as much correlation across multiple modalities. As such, the increased precision of second stage 414 may be called into action for examining such areas, regardless of whether first stage 406 generates a proposal.

Dynamic injection locations 902-2 may be defined based on one or more trigger conditions 903. For instance, a dynamic injection location may correspond to a mapped object (e.g., a stop sign, a crosswalk, a traffic alert beacon) which the system may detect and, responsive to the detection, inject a proposal associated with the mapped object to ensure second stage 414 activates to closely examine the sensor data associated with that area.

Based on injection locations 902, perception system 240 may generate injected object detection outputs 904. Injected object detection outputs 904 may be input to second stage 414 along with proposed object detection outputs 412. Injected object detection outputs 904 may be defined in a format compatible with organically proposed outputs from first stage 406. In this manner, for instance, a data structure (e.g., tensor) of proposed object detections from stage 406 may be extended to include the injected object detections. The injection pathway may use the same input structures as organic proposals. Injected object detection outputs 904 may include injected values for one or more attributes, such as object class (e.g., a not-null object class value), object extents (e.g., bounding box dimensions), object heading, or other object attributes. Injected values may be initialized with random values or may be initialized based on mean or learned values from a training dataset or other corpus of examples of such objects.

In an example, perception system 240 may execute second stage 414 over the injected object detections in the same manner as the organically proposed object detections. For instance, second stage 414 may select local context data for an injection location in the representation of the environment. The injection location may be a location for which the first stage did not output a corresponding detection result that indicates a corresponding proposed detected object at the location. The local context data may include, just as for an organic proposal, a portion of sensor data or a portion of latent feature data. Second stage 414 may generate, based on the local context data and an injected value of an injected object detection at the injection location (e.g., an injected probability of an object being present, an injected initialized bounding box), an updated value. Second stage 414 may generate the object detection output based on the updated value. The object detection output may include an object detection located at the injection location. The object detection output may not include an object detection located at the injection location.

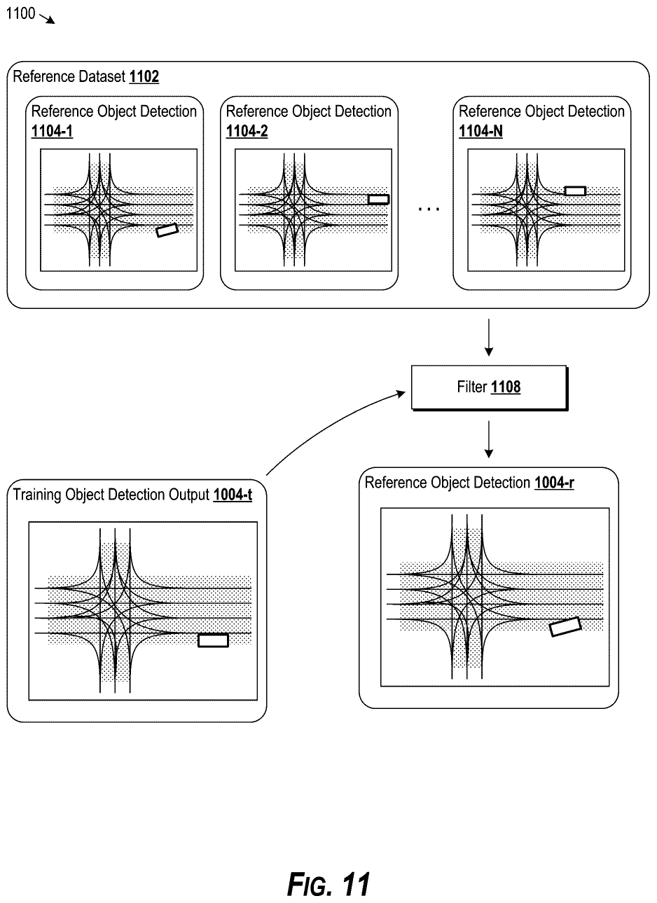

FIG. 10 is a block diagram 1000 of aspects of an example system for training perception system 240 according to example aspects of the present disclosure. In training, perception system 240 may process a training environmental data input 1002 (e.g., such as environmental data 402) to generate a training object detection output 1004-t (e.g., corresponding to object detection output 420). Training object detection output 1004-t may include training attribute data 1006-t.

To train perception system 240, the training output(s) may be compared to a reference. Reference object detection 1004-r may represent a ground truth or labeled output. Reference object detection 1004-r may include reference attribute data 1004-r.

Training system 1008 may compare training object detection output 1004-t and reference object detection 1004-r. Training system 1008 may execute matching model 1010 over training object detection output 1004-t and reference object detection 1004-r to evaluate a match therebetween. Training system 1008 may compute a loss 1012 to quantify a performance of perception system 240. Training system 1008 may generate one or more updates to perception system 240 based on loss 1012. Training system 1008 may update perception system 240 based on the generated updates (e.g., to update one or more learnable parameters of a model of perception system 240).

Training environmental data input 1002 may be or include data as described above with respect to environmental data 402.

Training object detection output 1004-t may be or include data as described above with respect to object detection output 420. For instance, attribute data 1006-t may include data describing object class, object extent, object boundary, or other object attributes.

Reference object detection 1004-r may be or include data as described above with respect to object detection output 420. For instance, reference attribute data 1006-r may include data describing object class, object extent, object boundary, or other object attributes.

Training system 1008 may be or include one or more hardware or software elements (e.g., a computing system) operable to execute operations that evaluate an output of perception system 240 against a reference and train perception system 240, or a portion thereof.

Matching model 1010 may be or include matching logic configured to compare object detection outputs to evaluate a similarity therebetween. In general, matching model 1010 may measure the performance of the perception system by identifying whether the system accurately recognized and tracked objects in an environment. Matching model 1010 may quantify accuracy by comparison against known label data that identifies ground truth object data (e.g., object type, object position, etc.). Naively measuring accuracy and requiring identity between the perception output and the label may render the problem intractable. To help determine whether a prediction is of sufficient quality, the comparison between the perception outputs and the label data may be multifaceted, with different learned weights applied to adjust the influence of each factor on the comparison output.

In general, the goal of a perception system may be to parse an input scene with sufficient accuracy such that reasonable human drivers would be equipped to respond to the scene if presented with the parsed scene information or the ground truth scene information. In other words, the goal of a perception system may be to capture sufficiently accurate information that would enable the same set of reasonable reactions as would be enabled by ground truth information. For example, a 20 cm error in a lateral lane position of a vehicle at a distance of 200 m may not affect a reasonable human driver's navigation of the scene as compared to the ground truth lane position. The same magnitude error when the vehicle is alongside the driver's position may affect the driver's navigation of the scene as compared to the ground truth lane position.

While human drivers may quickly view a scene and ingest the information that is relevant to a driving task, it is much harder to describe a priori. The boundary between immaterial and material errors may be extremely complex and shaped by numerous parameters. Attempting to hand-tune an exhaustive list of comparison features to determine whether a perception output is “good enough” may be time-consuming, error-prone, or simply intractable.

Advantageously, example implementations of matching model 1010 may provide highly interpretable and efficiently maintainable approaches to learning representations of complex decision boundaries. Matching model 1010 may employ a machine-learned model to map the complex decision boundary around valid matches. The machine-learned model may discern between material and immaterial divergences between perception outputs and labels. The machine-learned model may adjust the influence of component divergence values on an ultimate aggregate divergence value that characterizes the overall quality of the match. Matching model 1010 may thus be capable of determining that a perception output is materially equivalent to the ground truth label, even if they diverge in aspects that are immaterial to performance.

For example, matching model 1010 may process the perception outputs and the label data using multiple divergence metrics configured to characterize aspects in which the perception outputs diverge from the label data. Matching model 1010 may input data from the perception outputs and data from the labels to the divergence metrics to obtain component divergence values. Matching model 1010 may form an overall judgment regarding the differences between the perception outputs and the label data using an aggregate divergence value that flows from the various component divergence values. Machine-learned weights may be applied to transform features of the divergences to help quantify the materiality of differences between the perception outputs and the label data. Matching model 1010 may cause more material divergences to have a greater influence on the aggregate divergence value than less material divergences.

Matching model 1010 may self-calibrate using a dataset of unit tests. The unit tests may include a variety of data pairs. For example, a unit test may be a pair of perception outputs and label data that are known to be an accurate match (e.g., a sufficiently accurate perception output). A unit test may be a pair of perception outputs and label data that are known to be an inaccurate match (e.g., a perception output that tracks an object with too much error). A unit test may be a pair of perception outputs and label data that are known to be a spurious pairing (e.g., the perception output fails to correspond to any label). Matching model 1010 may learn values for one or more learnable parameters by fitting its evaluation outputs to the known match labels of the unit tests. For instance, matching model 1010 may perform an optimization routine to determine weight values that cause the aggregate divergence values for each unit test to correspond to a range of values associated with the known match label for that test (e.g., above a first threshold for an accurate match, between the first threshold and a second threshold for an inaccurate match, below a third threshold for a spurious pair, etc.).

Using unit tests to self-calibrate may simplify and accelerate the refinement of matching model 1010. For example, if matching model 1010 does not correctly match a pair of perception outputs and label data, then that incorrect match may be corrected and added as a unit test. Matching model 1010 may then re-calibrate over the new set of unit tests. Matching model 1010 itself may adapt its weighting to refine the decision boundary without requiring extensive manual deconstruction of each failure mode.

To maintain performance on new match pairs (e.g., not in the bank of unit tests), matching model 1010 may employ constraints to avoid overfitting. Matching model 1010 may constrain the weights to a half-space of possible values so that the direction of a particular metric's contribution to the aggregate value is preserved. For instance, the magnitude of an angular rotation between a predicted bounding box and a label bounding box may be a divergence metric, such that a penalty is applied based on the amount of angular misalignment. A weight applied to this divergence metric may be constrained to be positive to prevent matching model 1010 from flipping the sign of the weight and treating angular misalignment as a reward.

To facilitate improved interpretability, matching model 1010 may constrain the aggregate divergence computation to be linear in its parameters. For instance, this constraint may allow for confirmation that—all else being equal—a change in a component divergence value will cause the aggregate divergence value to change in an expected direction. For instance, while the magnitude of an impact of angular misalignment on an overall aggregate divergence value may be learned implicitly, matching model 1010 may support explicit constraints that cause an increase in angular misalignment to—all else being equal—result in a worse match score.

Different divergence metrics may have different importance in different contexts. For instance, angular misalignment of a bounding box may be significant when the object is very close to the autonomous vehicle. However, for distant objects, angular misalignment may not be as important. Using a constant weight for angular misalignment may not reflect variations in the practical value of accuracy in such contexts.

Matching model 1010 may use context metrics to weight divergence values differently in different contexts. Matching model 1010 may use context metrics that are also linear in the parameters of the metrics. Matching model 1010 may also use learnable parameters in the context metrics to help calibrate the context metrics. The learnable parameters in the context metrics may also be constrained to preserve the intended contribution of the context metric.

To preserve the linearity of matching model 1010 in all its parameters, example implementations may determine the aggregate divergence value using a tensor product of one or more linear context metrics and one or more linear divergence metrics. Each component divergence metric or component context metric may be piecewise linear. In this manner, matching model 1010 may adapt to different contexts while preserving the interpretability, performance, and efficient optimization of linear systems.

A failure of self-calibration (e.g., in which no solution is found that satisfies all unit tests) may provide a signal that matching model 1010 is missing a pertinent divergence metric or is not ingesting some piece of relevant context. For example, a human reviewer may determine that a misalignment error of a bounding box for an emergency vehicle would be an important error, even at long range. The reviewer may add the correct match label (e.g., indicating a failure to match) and add the pair as a unit test. While normally this error might not be as significant, it may be understood that driving behavior may be more strongly affected by the movement of emergency vehicles than non-emergency vehicles. If matching model 1010 does not self-calibrate to fit this new unit test, the failure may be a signal that matching model 1010 may benefit from consuming additional context, such as an “active_emer_vehicle” flag that is associated with detected active emergency vehicles.

Additionally, for example, by giving each weight limited power, the self-calibration of matching model 1010 may have more limited opportunity to overfit by exploiting any given metric's weight to compensate for missing context. For instance, in the above emergency vehicle example, a highly nonlinear weighting configuration could potentially overfit by learning to artificially penalize angular misalignment in a narrow range associated with that single unit test. In this manner, for instance, an explicit failure of matching model 1010 to self-calibrate may surface areas for improvement that might be hidden if using more complex configurations.

Further details of example implementations of matching model 1010 are described in U.S. patent application Ser. No. 18/628,336, which was filed Apr. 5, 2024, and is hereby incorporated by reference herein in its entirety.

In an example, matching model 1010 executes based on an assumed state in which a timestamp associated with training object detection input 1002 is the same as a timestamp associated with reference object detection output 1006-r.

Matching model 1010 may output a score. Based on comparison between the score and a threshold, training system 1008 may compute a match state between the training output and the label. Detections that are matched to a label may be treated as positive training examples. Detections that are not matched to a label may be treated as negative training examples.

To balance negative and positive classification losses, training system 1008 may multiply the positive losses of each scene with (biased_positive_counts+biased_negative_counts)/biased_positive_counts. In an example, biased_negative_counts=100+actual_negative_counts and biased_positive_counts=100+actual_positive_counts. Training system 1008 may multiply the negative classification loss with a similar multiplier. These multipliers may operate to cause positive and negative losses to be more similar on each scene and avoid too many losses on crowded scenes.

Training system 1008 may execute matching model 1010 over pairwise groupings of training object detection outputs and reference object detections. In this manner, for instance, each training object detection output may have a match value attribute “is_in_match” that indicates that the output is in a match with a reference. The match value may be a binary flag.

Loss 1012 may be or include a classification loss. A classification loss may include a binary cross entropy loss. A classification loss may include a binary cross entropy loss evaluated between logit values output by perception system 240 (e.g., updated logit values, such as logit values based on a combination of first stage and second stage logits) and a match value.

In an example, loss 1012 may include a loss expressed as BCE(logits, is_in_match)*weight, where a weight may be obtained based on an object category, a status of the object as on a highway (e.g., an “on_highway” flag), or a status of an object as being near a roadway (e.g., “near_roadway” flag). For example, detections that are far from a roadway may be downweighted with a multiplier 0.1. Losses on highway may be upweighted with multiplier 5.0. These weights may be adjusted per object category.

Loss 1012 may be or include a regression loss. A regression loss may be computed using a negative log likelihood loss. An example regression loss may be expressed as −log_prob(mean_of_regressed_value, original_scale). The mean of the regressed value may be an updated value obtained from second stage 414. In an example, the regression losses of an attribute are computed if (e.g., and only if) some category does learn the regression delta.

In this manner, for instance, training system 1008 may operate to train an object detection system of perception system 240. Perception system 240 may generate, based on processing sensor data representing an environment, an object detection output indicating an object boundary and a prediction value for an attribute of a detected object in the environment. Training system 1008 may generate a match value using a matching model that evaluates a match quality between the object boundary and a ground truth object boundary. Training system 1008 may compute a loss that evaluates the prediction value against the match value (e.g., the cross-entropy loss described above). Training system 1008 may update, using the loss, one or more learnable parameters of perception system 240.

In some examples, training system 1008 may train a two-stage perception system 240 as described herein. Training system 1008 may train the stages jointly or individually. In an example, training system 1008 may train the first stage, then freeze the first stage while training the second stage, and then fine-tune both stages jointly, using the values obtained during the prior individual trainings to provide a warm-start condition for the joint training.

In some examples, training system 1008 may train a two-stage perception system 240 end to end, with losses only computed over the outputs of the second stage. Losses can include losses 1012. Losses can include a per-label loss to improve recall over all possible labels.

In an example, training system 1008 incorporates a validation function into a loss computation. For instance, implementations of matching model 1010 may be used to validate perception system 240, as described in U.S. patent application Ser. No. 18/628,336. Incorporating the same matching model into the loss computation may help align learning targets and validation methods, which may advantageously help the training system naturally improve performance in ways that are important to the metrics against which the overall system is validated.

As mentioned above, training system 1008 may execute matching model 1010 over pairwise groupings of training object detection outputs and reference object detections. The number of pairwise matches evaluated may be reduced using a filter.

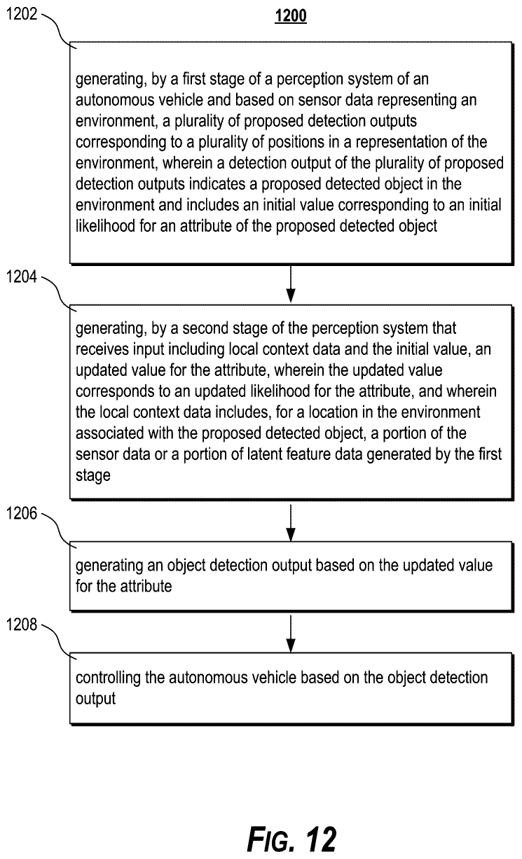

FIG. 11 is a block diagram 1100 of aspects of an example system for training perception system 240 according to example aspects of the present disclosure. Reference dataset 1102 may contain N reference object detections 1104-1, 1104-2, . . . , 1104-N (e.g., which may be or contain data as described above with respect to reference object detection 1004-r). However, some reference detections may be obviously unrelated to a given training object detection output 1004-t. Filter 1108 can operate over reference dataset 1102 to screen out references that are not sufficiently related to training object detection output 1004-t to advance the computation to using matching model 1010. If no references are returned by filter 1108, training object detection output 1004-t may be marked as unmatched (e.g., a null match value) without having to execute matching model 1010.

Filter 1108 may include a proximity filter. In an example, only a subset of references might be within a threshold distance of training object detection output 1004-t. Matching model 1010 may only execute pairwise comparisons over this subset. A threshold distance may be defined based on center distance, keypoint distance, or both. An example keypoint threshold distance is four meters. An example center point threshold distance is five meters. The threshold distance may vary depending on object class. For instance, a pedestrian detection center may be constrained to be within 2 m of label centers to be considered a candidate match.

Filter 1108 may include a category or class filter. In an example, filter 1108 screens out cross-category mismatches. For instance, filter 1108 can screen out any references that do not match an object class associated with training object detection output 1004-t.

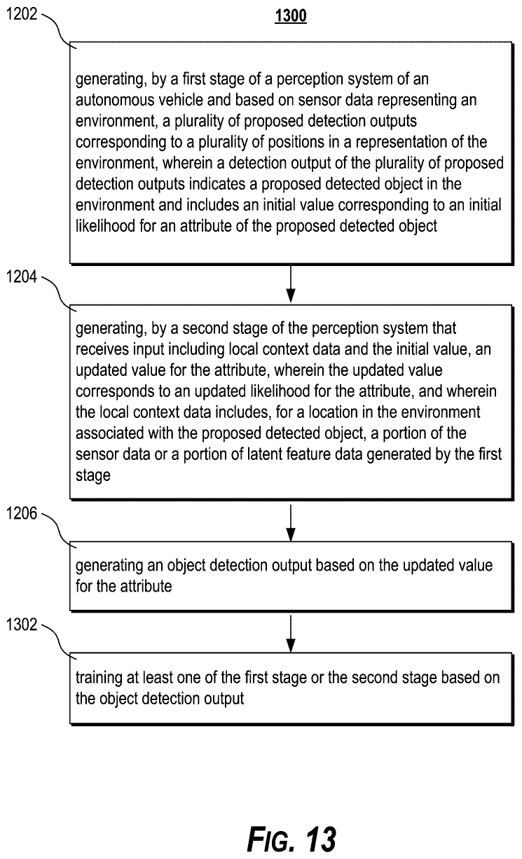

FIG. 12 is a flowchart of an example method 1200 according to aspects of the present disclosure. One or more portions of example method 1200 may be implemented by the computing systems described with reference to the other figures (e.g., autonomous platform 110, vehicle computing system 180, remote system 160, a system of FIGS. 1 to 16). Each respective portion of example method 1200 may be performed by any (or any combination) of one or more computing devices. Moreover, one or more portions of example method 1200 may be implemented on the hardware components of the devices described herein (e.g., as in FIGS. 1 to 16).

FIG. 12 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of example method 1200 may be performed additionally, or alternatively, by other systems.

At 1202, example method 1200 includes generating, by a first stage of a perception system of an autonomous vehicle and based on sensor data representing an environment, a plurality of proposed detection outputs corresponding to a plurality of positions in a representation of the environment. In some implementations, a detection output of the plurality of proposed detection outputs indicates a proposed detected object in the environment and includes an initial value corresponding to an initial likelihood for an attribute of the proposed detected object.

For example, the first stage may be first stage 406 of perception system 240. The sensor data representing the environment may be or be included within environmental data 402. The plurality of proposed detection outputs may be or include proposed object detection outputs 412. The plurality of positions in the representation of the environment may correspond to a plurality of areas of the environment for which first stage 406 generates a prediction regarding whether the area contains at least a portion of an object. The detection output may be, for example, an output value corresponding to a position in the representation of the environment. The detection output may be, for instance, an example proposed detection output 412-1. For instance, example proposed detection output 412-1 may indicate a proposed detected object in the environment (e.g., indicate a likelihood that an object is present at the corresponding position). Example proposed detection output 412-1 may include an initial value corresponding to an initial likelihood for an attribute of the proposed detected object. For instance, example proposed detection output 412-1 may include a logit associated with a candidate object class of a plurality candidate object classes.

At 1204, example method 1200 includes generating, by a second stage of the perception system that receives input including local context data and the initial value, an updated value for the attribute. In some implementations, the updated value corresponds to an updated likelihood for the attribute. In some implementations, the local context data includes, for a location in the environment associated with the proposed detected object, a portion of the sensor data or a portion of latent feature data generated by the first stage.

For example, the second stage may be second stage 414. Second stage 414 may receive local context data as input including a portion of the sensor data from environmental data 402 or a portion of latent feature data from intermediate features 408 generated by first stage 406. Second stage 414 may receive an initial value from example proposed object detection 412-1 as input. Second stage 414 may generate an updated value for the initial value (e.g., an updated logit for an object class).

At 1206, example method 1200 includes generating an object detection output based on the updated value for the attribute. For example, perception system 240 may generate object detection outputs 420 (e.g., as part of perception data 245).

At 1208, example method 1200 includes controlling the autonomous vehicle based on the object detection output. For example, autonomy systems 200 may control an autonomous platform based on perception data 245.

In some implementations, example method 1200 includes generating, by a classification portion of the first stage, one or more scores for a plurality of output classes, wherein the one or more scores comprise the initial value. For example, the score(s) may be logits or other values used to compare and select a likely candidate from among multiple candidate options.

In some implementations, example method 1200 includes generating, by a regression portion of the first stage, a measurement value of a boundary associated with the proposed detected object. For example, first stage 406 may include one or more layers of regression model (e.g., in prediction layer(s) 410) configured to generate a value describing a border of a bounding box or a position of a center or corner point of a bounding box. In some implementations, example method 1200 includes generating, by a regression portion of the first stage, a measurement value of a velocity associated with the proposed detected object.

In some implementations, example method 1200 includes generating, using a neural network of the second stage and based on the initial value, a delta value, wherein the updated value is based on a combination of the initial value and the delta value. For example, second stage 414 may include one or more layers of regression model (e.g., in prediction layer(s) 418) that regress a delta value for a measurement. Second stage 414 may include one or more layers of a machine-learned model (e.g., in prediction layer(s) 418) that generate a delta value for a logit.

In some implementations, example method 1200 includes generating, for the attribute, a plurality of initial values. For example, layer(s) 410 of first stage 406 may generate initial values 502. In some implementations, one of the plurality of initial values is the initial value, and the plurality of initial values respectively correspond to a plurality of output classes for classifying the proposed detected object. For example, the score(s) may be logits or other values used to compare and select a likely candidate from among multiple candidate options.

In some implementations, example method 1200 includes processing the plurality of initial values and the local context data to generate a plurality of delta values respectively for the plurality of initial values. Second stage 414 may include one or more layers of a machine-learned model (e.g., in prediction layer(s) 418) that generate delta values 602. In some implementations, example method 1200 includes generating, based on the plurality of initial values and the plurality of delta values, a plurality of refined values, wherein one of the plurality of refined values is the updated value. For example, second stage 414 may generate updated values 504. In some implementations, example method 1200 includes selecting an output class for the attribute from the plurality of output classes based on the plurality of refined values. For example, prediction system 240 may classify the detect object based on updated values 504.

In some implementations of example method 1200, the initial likelihood corresponds to an initial likelihood that an attribute of the proposed detected object has a value corresponding to a particular class.

In some implementations of example method 1200, the updated value indicates, as compared to the initial value, a lower likelihood that a boundary of the proposed detected object is present at the location. In some implementations of example method 1200, the object detection output does not indicate any object detected at the location. In an example of false positive suppression, first stage 406 may output an initial value indicating a likelihood that a boundary of a proposed detected object is present at the location. Second stage 414 may output an updated value that indicates, as compared to the initial value, a lower likelihood that a boundary of the proposed detected object is present at the location, such that the final object detection outputs 420 do not indicate any object detected at the location.

In some implementations, example method 1200 includes generating a delta value based on the initial value and the local context data. For example, second stage 414 may generate delta values 602. In some implementations, example method 1200 includes combining the initial value and the delta value into a combined value. For example, initial values 502 may combine with delta values 602 to obtain updated values 504. In some implementations, example method 1200 includes generating the updated value based on the combined value. For example, initial values 502 may combine with delta values 602 to obtain updated values 504. In some implementations, the updated value for the attribute indicates an updated value for a measurement associated with the proposed detected object (e.g., a boundary, a velocity), and wherein the initial value indicates an initial value for the measurement.

In some implementations, example method 1200 includes selecting, by the perception system, additional local context data for an injection location in the representation of the environment. For example, perception system 240 may obtain one or more injection locations 902 at which it is desired to trigger second stage 414. In some implementations, the injection location is a location for which the first stage did not output a corresponding detection result that indicates a corresponding proposed detected object at the location. In some implementations, the additional local context data includes an additional portion of the sensor data or an additional portion of the latent feature data. In some implementations, example method 1200 includes generating, by the second stage of the perception system and based on the additional local context data and an injected value of an injected object detection at the injection location, an additional updated value (e.g., refining the injected object detection). In some implementations, the injected object detection indicates an injected proposed detected object that is not proposed by the first stage to be at the injection location. In some implementations, example method 1200 includes generating the object detection output based on the additional updated value. In this manner, for instance, a false negative may be avoided by forcing second stage 414 to operate over areas of particular interest.

In some implementations, example method 1200 includes receiving, by an input layer of the second stage, an input data structure of proposed object detections generated by the first stage. In some implementations, example method 1200 includes adding, to the input data structure, the injected object detection. For example, injected object detections may be added using a same input mechanism as organically proposed object detections. For instance, injected object detections may be added along a batch dimension to process in parallel, added to a queue to process in series, or mixtures thereof.

In some implementations, example method 1200 includes generating a motion plan based on the updated value for the attribute. For example, perception data 245 may contain the updated value. Motion planning system 250 may process perception data 245 to generate motion plans. In some implementations, example method 1200 includes controlling the autonomous vehicle using the motion plan. Control system 260 may process a motion plan to control an autonomous platform.

In some implementations of example method 1200, the plurality of positions in the representation of the environment correspond to a bird's eye view (BEV) grid over the environment. For example, a grid 702 may subdivide a region of the environment into subregions. Perception system 240 may generate a representation of the environment in which various sensor data is mapped into a BEV representation. For instance, point cloud data may be fused with image data or other modalities and represented as an overhead view of a region of an environment surrounding an ego vehicle.

In some implementations of example method 1200, the plurality of positions in the representation of the environment correspond to cells of the BEV grid, wherein the detection output indicates that a boundary of the proposed detected object is in a corresponding cell of the BEV grid. For example, a location 704 in grid 702 may correspond to raw sensor returns. First stage 406 may process data associated with location 704 and output an example proposed object detection that indicates a proposed object at location 704. The output from first stage 416 may indicate that a boundary of the proposed detected object is in a corresponding cell of the BEV grid.

In some implementations, example method 1200 includes processing, by the perception system and for a respective cell of the BEV grid, one or more respective portions of image data and LIDAR data that describe a portion of the environment located in the respective cell. For example, first stage 406 may process data associated with location 704 and output an example proposed object detection that indicates a proposed object at location 704.

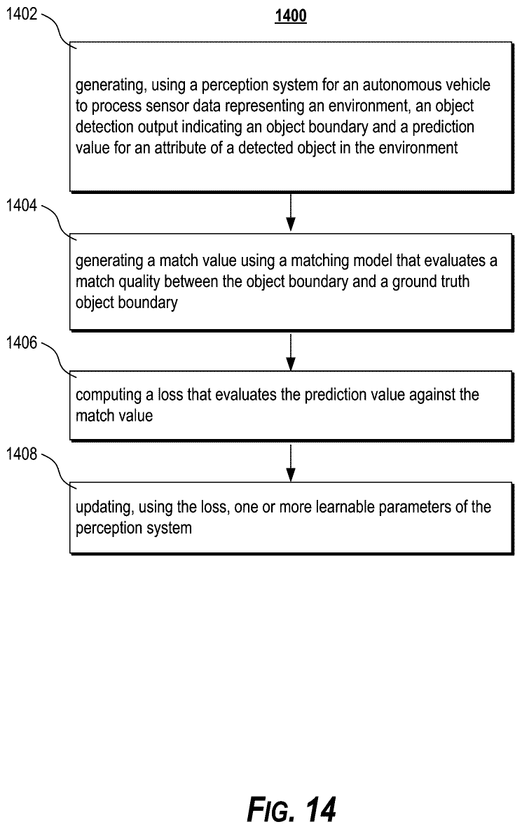

Training the perception system referenced in example method 1200 may include an example training method 1300 as shown in FIG. 13.

FIG. 13 is a flowchart of an example method 1300 according to aspects of the present disclosure. One or more portions of example method 1300 may be implemented by the computing systems described with reference to the other figures (e.g., autonomous platform 110, vehicle computing system 180, remote system 160, a system of FIGS. 1 to 16). Each respective portion of example method 1300 may be performed by any (or any combination) of one or more computing devices. Moreover, one or more portions of example method 1300 may be implemented on the hardware components of the devices described herein (e.g., as in FIGS. 1 to 16).

FIG. 13 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of example method 1300 may be performed additionally, or alternatively, by other systems.

Example method 1300 may include elements 1202, 1204, and 1206 as described above with respect FIG. 12.

At 1302, example method 1300 includes training at least one of the first stage or the second stage based on the object detection output (e.g., the object detection output generated at 1206). For example, training system 1008 may train the stages jointly or individually. In an example, training system 1008 may train the first stage, then freeze the first stage while training the second stage, and then fine-tune both stages jointly, using the values obtained during the prior individual trainings to provide a warm-start condition for the joint training.

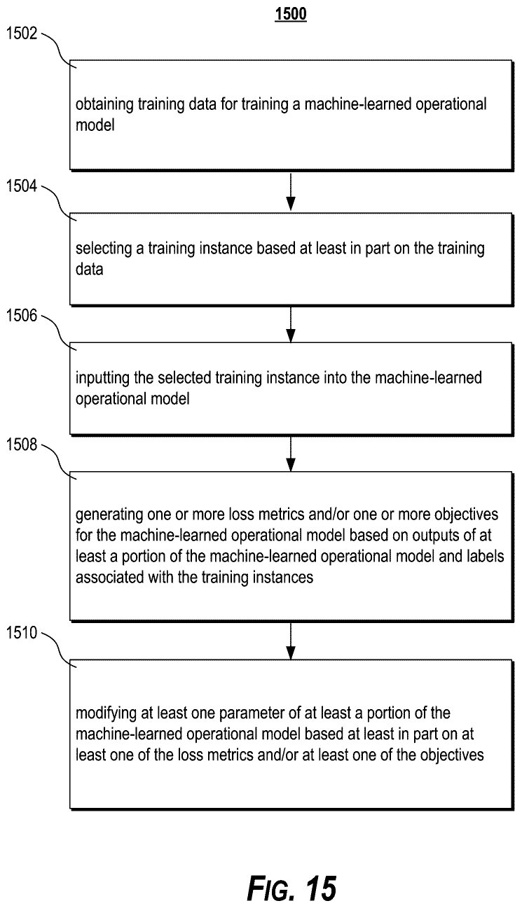

FIG. 14 is a flowchart of an example method 1400 for training a perception model according to aspects of the present disclosure. One or more portions of example method 1400 may be implemented by the computing systems described with reference to the other figures (e.g., autonomous platform 110, vehicle computing system 180, remote system 160, a system of FIGS. 1 to 16). Each respective portion of example method 1400 may be performed by any (or any combination) of one or more computing devices. Moreover, one or more portions of example method 1400 may be implemented on the hardware components of the devices described herein (e.g., as in FIGS. 1 to 16). FIG. 14 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of example method 1400 may be performed additionally, or alternatively, by other systems.

At 1402, example method 1400 includes generating, using a perception system for an autonomous vehicle to process sensor data representing an environment, an object detection output indicating an object boundary and a prediction value for an attribute of a detected object in the environment. For example, perception system 240 may process sensor data 204 and generate perception data 245 that contains an object detection output. For example, perception system 240 may process a training environmental data input 1002 (e.g., such as environmental data 402) to generate a training object detection output 1004-t (e.g., corresponding to object detection output 420).

At 1404, example method 1400 includes generating a match value using a matching model that evaluates a match quality between the object boundary and a ground truth object boundary. For example, training system 1008 may execute matching model 1010 over training object detection output 1004-t and reference object detection 1004-r to evaluate a match therebetween. For instance, training system 1008 may execute matching model 1010 to compare an object boundary indicated by training object detection output 1004-t and an object boundary indicated by reference object detection 1004-r to evaluate a match therebetween.

At 1406, example method 1400 includes computing a loss that evaluates the prediction value against the match value. For example, training system 1008 may compute a loss 1012 to quantify a performance of perception system 240.

At 1406, example method 1400 includes updating, using the loss, one or more learnable parameters of the perception system. For example, training system 1008 may generate one or more updates to perception system 240 based on loss 1012. Training system 1008 may update perception system 240 based on the generated updates (e.g., to update one or more learnable parameters of a model of perception system 240).

In some implementations of example method 1400, the loss is a cross-entropy loss between the prediction value and the match value. In some implementations of example method 1400, the loss is weighted based on at least one of the following ground truth attribute values: an object category (e.g., reducing or increasing a loss based on a per-category basis); an object on a highway (e.g., reducing or increasing a loss based on whether the object is on a highway); an object near a roadway (e.g., reducing or increasing a loss based on whether the object is near a roadway, such as based on a threshold distance).

In some implementations, example method 1400 includes generating, by the matching model, pairwise match values between the object boundary and the one or more candidate ground truth boundaries. For example, matching model 1010 may operate to provide pairwise comparison values. To find a valid comparison, training system 1008 may compare a generated object detection to a set of available references. For instance, if a generated detection doesn't exactly match any detection, matching model 1010 may help identify the reference which corresponds to the actual target object detected by perception system 240.

In some implementations, example method 1400 includes selecting the one or more candidate ground truth boundaries based on filtering a larger set of candidates using at least one of a proximity filter or a category filter. For example, filter 1108 may filter a larger reference dataset 1102 to extract reference object detection 1004-r. Filter 1108 may pass references that have a keypoint (e.g., center point, corner point) of a bounding box that falls within a threshold distance. Filter 1108 may pass references that are of a matching category.

In some implementations, example method 1400 includes implementing a two-stage perception system architecture described herein, such as with respect to FIG. 13. For instance, in some implementations, example method 1400 includes generating, by a first stage of the perception system and based on sensor data representing an environment, a plurality of proposed detection outputs corresponding to a plurality of positions in a representation of the environment, wherein the a detection output of the plurality of proposed detection outputs indicates a proposed detected object in the environment and includes an initial value corresponding to an initial likelihood for an attribute of the proposed detected object (e.g., as at 1202 in example method 1300). In some implementations, example method 1400 includes generating, by a second stage of the perception system that receives input including local context data and the initial value, an updated value for the attribute, wherein the updated value corresponds to an updated likelihood for the attribute, and wherein the local context data includes, for a location in the environment associated with the proposed detected object, a portion of the sensor data or a portion of latent feature data generated by the first stage (e.g., as at 1204 in example method 1300). In some implementations, example method 1400 includes generating the object detection output based on the updated value for the attribute (e.g., as at 1206 in example method 1300).

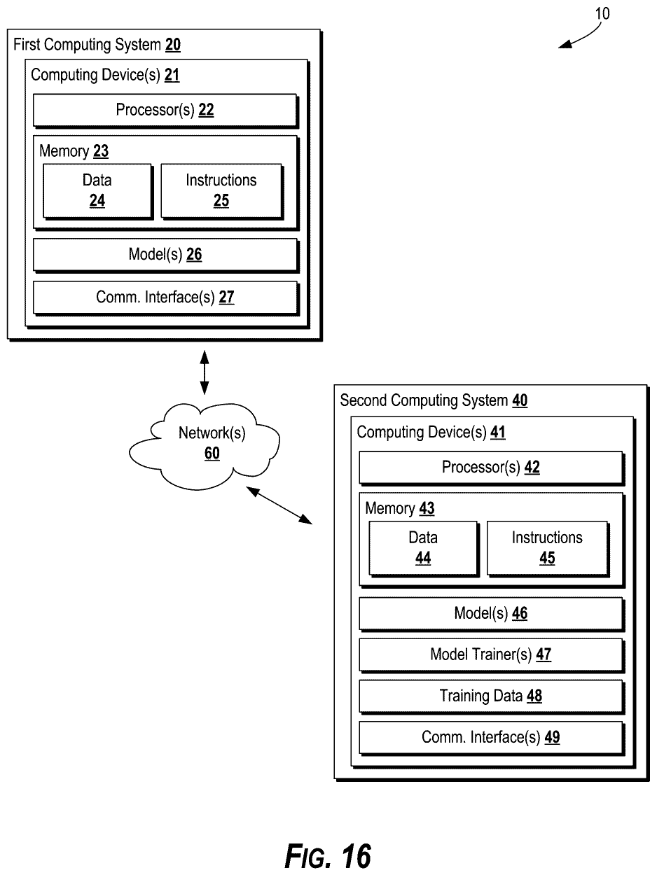

FIG. 15 is a flowchart of an example method 1500 for training one or more machine-learned operational models, according to aspects of the present disclosure. For instance, an operational system may include a machine-learned operational model. For example, one or more of localization system 230, perception system 240, planning system 250, control system 260, motion planning system 400 may include a machine-learned operational model that may be trained according to example method 1500.

One or more portions of example method 1500 may be implemented by a computing system that includes one or more computing devices such as, for example, the computing systems described with reference to the other figures (e.g., autonomous platform 110, vehicle computing system 180, remote system 160, a system of FIGS. 1 to 16). Each respective portion of example method 1500 may be performed by any (or any combination) of one or more computing devices. Moreover, one or more portions of example method 1500 may be implemented on the hardware components of the devices described herein (e.g., as in FIGS. 1 to 16), for example, to validate one or more systems or models.

FIG. 15 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of example method 1500 may be performed additionally, or alternatively, by other systems.

At 1502, example method 1500 may include obtaining training data for training a machine-learned operational model. The training data may include a plurality of training instances.

The training data may be collected using one or more autonomous platform 110s (e.g., autonomous platform 110) or the sensors thereof as autonomous platform 110 is within its environment. By way of example, the training data may be collected using one or more autonomous vehicles (e.g., autonomous platform 110, autonomous vehicle 110, autonomous vehicle 350) or sensors thereof as the vehicle operates along one or more travel ways. In some examples, the training data may be collected using other sensors, such as mobile-device-based sensors, ground-based sensors, aerial-based sensors, satellite-based sensors, or substantially any sensor interface configured for obtaining and/or recording measured data.

The training data may include a plurality of training sequences divided between multiple datasets (e.g., a training dataset, a validation dataset, or testing dataset). Each training sequence may include a plurality of pre-recorded perception datapoints, point clouds, images In some implementations, each sequence may include LIDAR point clouds (e.g., collected using LIDAR sensors of an autonomous platform 110), images (e.g., collected using mono or stereo imaging sensors), and the like. For instance, in some implementations, a plurality of images may be scaled for training and evaluation.

At 1504, example method 1500 may include selecting a training instance based at least in part on the training data.

At 1506, example method 1500 may include inputting the training instance into the machine-learned operational model.

At 1508, example method 1500 may include generating one or more loss metrics and/or one or more objectives for the machine-learned operational model based on outputs of at least a portion of the machine-learned operational model and labels associated with the training instances.

At 1510, example method 1500 may include modifying at least one parameter of at least a portion of the machine-learned operational model based at least in part on at least one of the loss metrics and/or at least one of the objectives. For example, a computing system may modify at least a portion of the machine-learned operational model based at least in part on at least one of the loss metrics and/or at least one of the objectives.

In some implementations, the machine-learned operational model may be trained in an end-to-end manner. For example, in some implementations, the machine-learned operational model may be fully differentiable.

After being updated, the operational model or the operational system including the operational model may be provided for validation. In some implementations, a validation system may evaluate or validate the operational system. The validation system may trigger retraining, decommissioning of the operational system based on, for example, failure to satisfy a validation threshold in one or more areas.

FIG. 16 is a block diagram of an example computing ecosystem 10 according to example implementations of the present disclosure. The example computing ecosystem 10 may include a first computing system 20 and a second computing system 40 that are communicatively coupled over one or more networks 60. In some implementations, the first computing system 20 or the second computing 40 may implement one or more of the systems, operations, or functionalities described herein for validating one or more systems or operational systems (e.g., the remote system 160, the onboard computing system 180, the autonomy system 200).

In some implementations, the first computing system 20 may be included in an autonomous platform 110 and be utilized to perform the functions of an autonomous platform 110 as described herein. For example, the first computing system 20 may be located onboard an autonomous vehicle and implement autonomy system for autonomously operating the autonomous vehicle. In some implementations, the first computing system 20 may represent the entire onboard computing system or a portion thereof (e.g., the localization system 230, the perception system 240, the planning system 250, the control system 260, or a combination thereof). In other implementations, the first computing system 20 may not be located onboard an autonomous platform 110. The first computing system 20 may include one or more distinct physical computing devices 21.

The first computing system 20 (e.g., the computing devices 21 thereof) may include one or more processors 22 and a memory 23. The one or more processors 22 may be any suitable processing device (e.g., a processor core, a microprocessor, an ASIC, a FPGA, a controller, a microcontroller) and may be one processor or a plurality of processors that are operatively connected. Memory 23 may include one or more non-transitory computer-readable storage media, such as RAM, ROM, EEPROM, EPROM, one or more memory devices, flash memory devices, and combinations thereof.

Memory 23 may store information that may be accessed by the one or more processors 22. For instance, the memory 23 (e.g., one or more non-transitory computer-readable storage media, memory devices) may store data 24 that may be obtained (e.g., received, accessed, written, manipulated, created, generated, stored, pulled, downloaded). The data 24 may include, for instance, sensor data, map data, data associated with autonomy functions (e.g., data associated with the perception, planning, or control functions), simulation data, or any data or information described herein. In some implementations, the first computing system 20 may obtain data from one or more memory devices that are remote from the first computing system 20.

Memory 23 may store computer-readable instructions 25 that may be executed by the one or more processors 22. Instructions 25 may be software written in any suitable programming language or may be implemented in hardware. Additionally, or alternatively, instructions 25 may be executed in logically or virtually separate threads on the processors 22.

For example, the memory 23 may store instructions 25 that are executable by one or more processors (e.g., by the one or more processors 22, by one or more other processors) to perform (e.g., with the computing devices 21, the first computing system 20, or other systems having processors executing the instructions) any of the operations, functions, or methods/processes (or portions thereof) described herein. For example, operations may include implementing system validation.

In some implementations, the first computing system 20 may store or include one or more models 26. In some implementations, the models 26 may be or may otherwise include one or more machine-learned models (e.g., a machine-learned operational system). As examples, the models 26 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 may include one or more models for implementing subsystems of the autonomy system 200, including any of: the localization system 230, the perception system 240, the planning system 250, or the control system 260.

In some implementations, the first computing system 20 may obtain the one or more models 26 using communication interface 27 to communicate with the second computing system 40 over the network 60. For instance, the first computing system 20 may store the models 26 (e.g., one or more machine-learned models) in memory 23. The first computing system 20 may then use or otherwise implement the models 26 (e.g., by the processors 22). By way of example, the first computing system 20 may implement the models 26 to localize an autonomous platform 110 in an environment, perceive an environment of an autonomous platform 110 or objects therein, plan one or more future states of an autonomous platform 110 for moving through an environment, control an autonomous platform 110 for interacting with an environment

The second computing system 40 may include one or more computing devices 41. The second computing system 40 may include one or more processors 42 and a memory 43. The one or more processors 42 may be any suitable processing device (e.g., a processor core, a microprocessor, an ASIC, a FPGA, a controller, a microcontroller) and may be one processor or a plurality of processors that are operatively connected. The memory 43 may include one or more non-transitory computer-readable storage media, such as RAM, ROM, EEPROM, EPROM, one or more memory devices, flash memory devices, and combinations thereof.

Memory 43 may store information that may be accessed by the one or more processors 42. For instance, the memory 43 (e.g., one or more non-transitory computer-readable storage media, memory devices) may store data 44 that may be obtained. The data 44 may include, for instance, sensor data, model parameters, map data, simulation data, simulated environmental scenes, simulated sensor data, data associated with vehicle trips/services, or any data or information described herein. In some implementations, the second computing system 40 may obtain data from one or more memory devices that are remote from the second computing system 40.

Memory 43 may also store computer-readable instructions 45 that may be executed by the one or more processors 42. The instructions 45 may be software written in any suitable programming language or may be implemented in hardware. Additionally, or alternatively, the instructions 45 may be executed in logically or virtually separate threads on the processors 42.

For example, memory 43 may store instructions 45 that are executable (e.g., by the one or more processors 42, by the one or more processors 22, by one or more other processors) to perform (e.g., with the computing devices 41, the second computing system 40, or other systems having processors for executing the instructions, such as computing devices 21 or the first computing system 20) any of the operations, functions, or methods/processes described herein. This may include, for example, the functionality of the autonomy system 200 (e.g., localization, perception, planning, control) or other functionality associated with an autonomous platform 110 (e.g., remote assistance, mapping, fleet management, trip/service assignment and matching). This may also include, for example, validating a machined-learned operational system.

In some implementations, second computing system 40 may include one or more server computing devices. In the event that the second computing system 40 includes multiple server computing devices, such server computing devices may operate according to various computing architectures, including, for example, sequential computing architectures, parallel computing architectures, or some combination thereof.

Additionally, or alternatively to, the models 26 at the first computing system 20, the second computing system 40 may include one or more models 46. As examples, the models 46 may be or may otherwise include various machine-learned models (e.g., a machine-learned operational system) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 may include one or more models of the autonomy system 200.

In some implementations, the second computing system 40 or the first computing system 20 may train one or more machine-learned models of the models 26 or the models 46 through the use of one or more model trainers 47 and training data 48. The model trainer 47 may train any one of the models 26 or the models 46 using one or more training or learning algorithms. One example training technique is backwards propagation of errors. In some implementations, the model trainer 47 may perform supervised training techniques using labeled training data. In other implementations, the model trainer 47 may perform unsupervised training techniques using unlabeled training data. In some implementations, the training data 48 may include simulated training data (e.g., training data obtained from simulated scenarios, inputs, configurations, environments). In some implementations, the second computing system 40 may implement simulations for obtaining the training data 48 or for implementing the model trainer 47 for training or testing the models 26 or the models 46. By way of example, the model trainer 47 may train one or more components of a machine-learned model for the autonomy system 200 through unsupervised training techniques using an objective function (e.g., costs, rewards, metrics, constraints). In some implementations, the model trainer 47 may perform a number of generalization techniques to improve the generalization capability of the models being trained. Generalization techniques include weight decays, dropouts, or other techniques.

For example, in some implementations, the second computing system 40 may generate training data 48 according to example aspects of the present disclosure. For instance, the second computing system 40 may generate training data 48. For instance, the second computing system 40 may implement methods according to example aspects of the present disclosure. The second computing system 40 may use the training data 48 to train models 26. For example, in some implementations, the first computing system 20 may include a computing system onboard or otherwise associated with a real or simulated autonomous vehicle. In some implementations, models 26 may include perception or machine vision models configured for deployment onboard or in service of a real or simulated autonomous vehicle. In this manner, for instance, the second computing system 40 may provide a training pipeline for training models 26.

The first computing system 20 and the second computing system 40 may each include communication interfaces 27 and 49, respectively. The communication interfaces 27, 49 may be used to communicate with each other or one or more other systems or devices, including systems or devices that are remotely located from the first computing system 20 or the second computing system 40. The communication interfaces 27, 49 may include any circuits, components, software for communicating with one or more networks (e.g., the network 60). In some implementations, the communication interfaces 27, 49 may include, for example, one or more of a communications controller, receiver, transceiver, transmitter, port, conductors, software or hardware for communicating data.

The network 60 may be any type of network or combination of networks that allows for communication between devices. In some implementations, the network may include one or more of a local area network, wide area network, the Internet, secure network, cellular network, mesh network, peer-to-peer communication link or some combination thereof and may include any number of wired or wireless links. Communication over the network 60 may be accomplished, for instance, through a network interface using any type of protocol, protection scheme, encoding, format, packaging

FIG. 16 illustrates one example computing ecosystem 10 that may be used to implement the present disclosure. For example, one or more systems or devices of ecosystem 10 may implement any one or more of the systems and components described in the preceding figures. Other systems may be used as well. For example, in some implementations, the first computing system 20 may include the model trainer 47 and the training data 48. In such implementations, the models 26, 46 may be both trained and used locally at the first computing system 20. As another example, in some implementations, the computing system 20 may not be connected to other computing systems. Additionally, components illustrated or discussed as being included in one of the computing systems 20 or 40 may instead be included in another one of the computing systems 20 or 40.

Computing tasks discussed herein as being performed at computing devices remote from autonomous platform 110 (e.g., autonomous vehicle) may instead be performed at autonomous platform 110 (e.g., via a vehicle computing system of the autonomous vehicle), or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . may be used to illustrate operations. Such identifiers are provided for the case of the reader and do not denote a particular order of steps or operations. An operation illustrated by a list identifier of (a), (i) may be performed before, after, or in parallel with another operation illustrated by a list identifier of (b), (ii)

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for object detection, the method comprising:
generating, by a first stage of a perception system of an autonomous vehicle and based on sensor data representing an environment, a plurality of proposed detection outputs corresponding to a plurality of positions in a representation of the environment, wherein a detection output of the plurality of proposed detection outputs indicates a proposed detected object in the environment and comprises an initial value corresponding to an initial likelihood for an attribute of the proposed detected object;
generating, by a second stage of the perception system that receives input including local context data and the initial value, an updated value for the attribute, wherein the updated value corresponds to an updated likelihood for the attribute, and wherein the local context data comprises, for a location in the environment associated with the proposed detected object, a portion of the sensor data or a portion of latent feature data generated by the first stage;
generating an object detection output based on the updated value for the attribute; and
controlling the autonomous vehicle based on the object detection output.

2. The computer-implemented method of claim 1, comprising:
generating, by a classification portion of the first stage, one or more scores for a plurality of output classes, wherein the one or more scores comprise the initial value; and
generating, by a regression portion of the first stage, a measurement value of:
a boundary associated with the proposed detected object; or
a velocity associated with the proposed detected object.

3. The computer-implemented method of claim 1, comprising:
generating, using a neural network of the second stage and based on the initial value, a delta value, wherein the updated value is based on a combination of the initial value and the delta value.

4. The computer-implemented method of claim 1, comprising:
generating, for the attribute, a plurality of initial values, wherein one of the plurality of initial values is the initial value, wherein the plurality of initial values respectively correspond to a plurality of output classes for classifying the proposed detected object;
processing the plurality of initial values and the local context data to generate a plurality of delta values respectively for the plurality of initial values;
generating, based on the plurality of initial values and the plurality of delta values, a plurality of refined values, wherein one of the plurality of refined values is the updated value; and
selecting an output class for the attribute from the plurality of output classes based on the plurality of refined values.

5. The computer-implemented method of claim 1, wherein the initial likelihood corresponds to an initial likelihood that an attribute of the proposed detected object has a value corresponding to a particular class.

6. The computer-implemented method of claim 1, wherein:
the updated value indicates, as compared to the initial value, a lower likelihood that a boundary of the proposed detected object is present at the location; and
the object detection output does not indicate any object detected at the location.

7. The computer-implemented method of claim 1, comprising:
generating a delta value based on the initial value and the local context data;
combining the initial value and the delta value into a combined value;
generating the updated value based on the combined value, wherein the updated value for the attribute indicates an updated value for a measurement associated with the proposed detected object, and wherein the initial value indicates an initial value for the measurement.

8. The computer-implemented method of claim 1, comprising:
selecting, by the perception system, additional local context data for an injection location in the representation of the environment, wherein the injection location is a location for which the first stage did not output a corresponding detection result that indicates a corresponding proposed detected object at the location, wherein the additional local context data comprises an additional portion of the sensor data or an additional portion of the latent feature data;
generating, by the second stage of the perception system and based on the additional local context data and an injected value of an injected object detection at the injection location, an additional updated value, wherein the injected object detection indicates an injected proposed detected object that is not proposed by the first stage to be at the injection location; and
generating the object detection output based on the additional updated value.

9. The computer-implemented method of claim 8, comprising:
receiving, by an input layer of the second stage, an input data structure of proposed object detections generated by the first stage; and
adding, to the input data structure, the injected object detection.

10. The computer-implemented method of claim 1, comprising:
generating a motion plan based on the updated value for the attribute; and
controlling the autonomous vehicle using the motion plan.

11. The computer-implemented method of claim 1, wherein the plurality of positions in the representation of the environment correspond to a bird's eye view (BEV) grid over the environment.

12. The computer-implemented method of claim 11, wherein the plurality of positions in the representation of the environment correspond to cells of the BEV grid, wherein the detection output indicates that a boundary of the proposed detected object is in a corresponding cell of the BEV grid.

13. The computer-implemented method of claim 11, comprising:
processing, by the perception system and for a respective cell of the BEV grid, one or more respective portions of image data and LIDAR data that describe a portion of the environment located in the respective cell.

14. A computer-implemented method for training an object detection system, the method comprising:
generating, using a perception system for an autonomous vehicle to process sensor data representing an environment, an object detection output indicating an object boundary and a prediction value for an attribute of a detected object in the environment;
generating a match value using a matching model that evaluates a match quality between the object boundary and a ground truth object boundary;
computing a loss that evaluates the prediction value against the match value; and
updating, using the loss, one or more learnable parameters of the perception system.

15. The computer-implemented method of claim 14, wherein the loss is a cross-entropy loss between the prediction value and the match value.

16. The computer-implemented method of claim 14, wherein the loss is weighted based on at least one of the following ground truth attribute values:
an object category;
an object on a highway; or
an object near a roadway.

17. The computer-implemented method of claim 14, comprising:
generating, by the matching model, pairwise match values between the object boundary and one or more candidate ground truth boundaries.

18. The computer-implemented method of claim 17, comprising:
selecting the one or more candidate ground truth boundaries based on filtering a larger set of a plurality of candidate ground truth boundaries using at least one of:
a proximity filter; or
a category filter.

19. The computer-implemented method of claim 14, comprising:
generating, by a first stage of the perception system and based on sensor data representing an environment, a plurality of proposed detection outputs corresponding to a plurality of positions in a representation of the environment, wherein the a detection output of the plurality of proposed detection outputs indicates a proposed detected object in the environment and comprises an initial value corresponding to an initial likelihood for an attribute of the proposed detected object;
generating, by a second stage of the perception system that receives input including local context data and the initial value, an updated value for the attribute, wherein the updated value corresponds to an updated likelihood for the attribute, and wherein the local context data comprises, for a location in the environment associated with the proposed detected object, a portion of the sensor data or a portion of latent feature data generated by the first stage; and
generating the object detection output based on the updated value for the attribute.

20. An autonomous vehicle control system for controlling an autonomous vehicle, the autonomous vehicle control system comprising:
a perception system that comprises one or more sensors;
one or more processors; and
one or more non-transitory, computer-readable media storing instructions that are executable by the one or more processors to cause the autonomous vehicle control system to perform operations, the operations comprising:
generating, by the one or more sensors, sensor data representing an environment;
generating, by a first stage of the perception system and based on the sensor data, a plurality of proposed detection outputs corresponding to a plurality of positions in a representation of the environment, wherein a detection output of the plurality of proposed detection outputs indicates a proposed detected object in the environment and comprises an initial value corresponding to an initial likelihood for an attribute of the proposed detected object;
generating, by a second stage of the perception system that receives input including local context data and the initial value, an updated value for the attribute, wherein the updated value corresponds to an updated likelihood for the attribute, and wherein the local context data comprises a portion of the sensor data or a portion of latent feature data generated by the first stage, for a location in the environment associated with the proposed detected object;
generating an object detection output based on the updated value for the attribute; and
controlling the autonomous vehicle based on the object detection output.
